(19) United States
(12) Patent Application Publication
(10) Pub. No.: US 2014/0349226 A1
(43) Pub. Date: Nov. 27, 2014

(54) ELECTROPHOTOGRAPHIC PHOTOSENSITIVE MEMBER AND ELECTROPHOTOGRAPHIC APPARATUS

(71) Applicant: CANON KABUSHIKI KAISHA, Tokyo (JP)

(72) Inventors: Yukihiro Abe, Mishima-shi (JP); Takanori Ueno, Mishima-shi (JP); Hironori Owaki, Susono-shi (JP); Tomohito Ozawa, Mishima-shi (JP); Jun Ohira, Yokohama-shi (JP); Masaki Mizutani, Susono-shi (JP)

(73) Assignee: CANON KABUSHIKI KAISHA, Tokyo (JP)

(21) Appl. No.: 14/287,720

(22) Filed: May 27, 2014

(30) Foreign Application Priority Data
May 27, 2013 (JP) 2013-111368
Feb. 6, 2014 (JP) 2014-021787

(51) Int. Cl. G03G 15/00

(52) U.S. Cl. CPC G03G 5/14708
USPC 430/56; 399/159

(57) ABSTRACT

Provided is an electrophotographic photosensitive member that improves the sensitivity characteristic and high-humidity deletion resistance, and achieves compatibility between a high image-resolving power and the suppression of an image memory. The electrophotographic photosensitive member comprises an electrophotographic photosensitive member, including: a photoconductive layer; and a surface layer comprising hydrogenated amorphous silicon carbide on the photoconductive layer, in which: a ratio (C/(Si+C)) of a number of carbon atoms (C) to a sum of a number of silicon atoms (Si) and the number of the carbon atoms (C) in the surface layer is 0.50 or more and 0.65 or less; a sum of an atom density of the silicon atoms and an atom density of the carbon atoms in the surface layer is 6.60×10²² atoms/cm³ or more; and a defect density of the surface layer determined by electron spin resonance measurement is 9.0×10¹⁸ spins/cm³ or more and 2.2×10¹⁹ spins/cm³ or less.

### BACKGROUND OF THE INVENTION

1. Field of the Invention

The present invention relates to an electrophotographic photosensitive member including a surface layer comprising (formed of) hydrogenated amorphous silicon carbide, and to an electrophotographic apparatus including the electrophotographic photosensitive member.

2. Description of the Related Art

An amorphous silicon photosensitive member using amorphous silicon such as hydrogenated amorphous silicon in its photoconductive layer has been known as an electrophotographic photosensitive member made of an inorganic material. It should be noted that the amorphous silicon is hereinafter sometimes referred to as “a-Si”. In addition, the electrophotographic photosensitive member is sometimes simply referred to as “photosensitive member”.

Examples of the construction of the a-Si photosensitive member include constructions in each of which a lower charge injection preventing layer, a photoconductive layer, and a surface layer are laminated in the stated order on a substrate. Of those, an a-Si photosensitive member in which hydrogenated amorphous silicon carbide is applied as a material for the surface layer has been known. It should be noted that the hydrogenated amorphous silicon carbide is hereinafter sometimes referred to as “a-SiC”. The a-SiC surface layer has been used mainly in an electrophotographic apparatus having a high process speed because the a-SiC surface layer is excellent in wear resistance.

Heretofore, the a-SiC surface layer has often been designed while priority has been placed on its wear resistance. Often selected as a process for improving the wear resistance is a composition having a high ratio (C/(Si+C)) of the number of carbon atoms (C) to the sum of the number of silicon atoms (Si) and the number of the carbon atoms (C) constituting the a-SiC surface layer. This is because of the following reason. A bonding force between carbon atoms is higher than a bonding force between a silicon atom and a carbon atom, and hence as the ratio (C/(Si+C)) increases, the number of bonds between carbon atoms increases and the bonding force of the a-SiC can be improved. On the other hand, the number of double bonds between carbon atoms also tends to increase as the ratio (C/(Si+C)) increases.

The increase in number of double bonds between carbon atoms is disadvantageous from the viewpoint of the light permeability of the a-SiC surface layer. In this case, the quantity of light that reaches the photoconductive layer reduces to cause a reduction in sensitivity of the photosensitive member. In addition, when the light permeability of the a-SiC surface layer is low, a fluctuation in sensitivity with the wear amount of the a-SiC surface layer enlarges. Accordingly, when the wear unevenness of the a-SiC surface layer occurs, the sensitivity unevenness of the photosensitive member occurs, which is responsible for image density unevenness.

The a-SiC surface layer has involved another problem in some cases. That is, when the a-SiC surface layer is used under an environment having a high absolute humidity, a letter blurs, or a letter is not printed and a blank dot occurs. Such phenomenon is hereinafter sometimes referred to as “high-humidity deletion”. The high-humidity deletion refers to the following image failure. When an image is output with an electrophotographic apparatus placed under an environment having a high absolute humidity, and after a while, an image is output again, a letter blurs or a letter is not printed and a blank dot occurs in the output image.

The high-humidity deletion has been considered to occur owing to a drift of charge caused by a reduction in resistance of the surface of the photosensitive member due to the adsorption of moisture to the surface of the photosensitive member. The high-humidity deletion is more likely to occur when the absolute humidity of the environment under which the electrophotographic apparatus is placed is higher or when a photosensitive member heater to be provided near the a-Si photosensitive member is not used.

According to Japanese Patent Application Laid-Open No. 2010-49241, compatibility between, high-humidity deletion resistance (suppressing effect on the high-humidity deletion) and the wear resistance has been achieved by satisfying the following requirements: the ratio (C/(Si+C)) of the number of carbon atoms (C) to the sum of the number of silicon atoms (Si) and the number of the carbon atoms (C) in the surface layer is set to 0.61 or more and 0.75 or less; and the sum of the atom density of the silicon atoms and the atom density of the carbon atoms in the surface layer is set to 6.60×10²² (atoms/cm³) or more.

In addition, the a-Si photosensitive member has heretofore been mounted mainly on a monochromatic electrophotographic apparatus adopting jumping development. The a-Si photosensitive member has been desired to additionally adapt to a development system such as two-component development as well in order for full colorization and an improvement in image quality in the future.

An increase in speed of an electrophotographic apparatus and its full colorization have steadily progressed in recent years, and hence a physical stress to be applied to the photosensitive member tends to be larger than the conventional one. Particularly in a field where an output image is treated as a commercial product like a POD market, an electrophotographic apparatus capable of stably outputting a high-quality image has been required more than ever before. In other words, the photosensitive member has been required to have high durability as well as a high image-resolving power.

The employment of a technology disclosed in Japanese Patent Application Laid-Open No. 2010-49241 can improve the wear resistance of the a-SiC surface layer of the photosensitive member. In the print-on-demand (POD) market, however, durability several to ten and several times as high as that in an office market has been required, and hence the approach involving merely improving the wear resistance has reached capacity. Therefore, the allowable range of the wear of the surface layer can be increased and the durability of the photosensitive member can be improved by laminating the surface layer in a thick manner while improving its wear resistance.

However, when the a-SiC surface layer is merely laminated in a thick manner by employing the conventional technology, the absorption of light by the a-SiC surface layer cannot be ignored, and hence a reduction in sensitivity characteristic and sensitivity unevenness resulting from wear unevenness become matters of concern. In addition, when the technology disclosed in Japanese Patent Application Laid-Open No. 2010-49241 is employed, film peeling has occurred owing to the residual stress of the laminated a-SiC surface layer in some cases.

Further, when the ratio (C(Si+C)) is set to a relatively low value and the wear resistance is improved by employing the technology disclosed in Japanese Patent Application Laid-Open No. 2010-49241 for the purpose of improving the light transmission through the a-SiC surface layer, the defect density of the a-SiC surface layer has increased in some cases.

In addition, the a-Si photosensitive member is desired to adapt to a development system such as two-component development in order for full colorization and an improvement in image quality. For example, when an a-Si photosensitive member whose a-SiC surface layer has a high defect density is applied to an electrophotographic apparatus of a two-component development system, charge injection has occurred from a developing sleeve to the photosensitive member through a magnetic carrier particle in a developing step to cause image blurring in some cases.

### SUMMARY OF THE INVENTION

In view of the foregoing, the present invention is directed to providing an electrophotographic photosensitive member that is excellent in sensitivity characteristic and high-humidity deletion resistance and achieves compatibility between a high image-resolving power and the suppression of an image memory, and is directed to providing an electrophotographic apparatus including the electrophotographic photosensitive member.

According to one aspect of the present invention, there is provided an electrophotographic photosensitive member includes: a photoconductive layer; and a surface layer comprising hydrogenated amorphous silicon carbide on the photoconductive layer, in which: a ratio (C/(Si+C)) of a number of carbon atoms (C) to a sum of a number of silicon atoms (Si) and the number of the carbon atoms (C) in the surface layer is 0.50 or more and 0.65 or less; a sum of an atom density of the silicon atoms and an atom density of the carbon atoms in the surface layer is 6.60×10²² atoms/cm³ or more; and a defect density of the surface layer determined by electron spin resonance measurement is 9.0×10¹⁸ spins/cm³ or more and 2.2×10¹⁹ spins/cm³ or less.

According to the present invention, the light permeability of the a-SiC surface layer improves and hence a sensitivity characteristic improves. In addition, high-humidity deletion resistance is improved by setting the sum of the atom density of the silicon atoms and the atom density of the carbon atoms in the a-SiC surface layer to a high value. The optimization of the defect density of the a-SiC surface layer can provide an electrophotographic photosensitive member that achieves compatibility between a high image-resolving power and the suppression of an image memory, and an electrophotographic apparatus including the electrophotographic photosensitive member.

Further features of the present invention will become apparent from the following description of exemplary embodiments with reference to the attached drawings.

### BRIEF DESCRIPTION OF THE DRAWINGS

FIG. 1A is a schematic sectional view of an electrophotographic photosensitive member of the present invention.

FIG. 1B is a schematic sectional view of the electrophotographic photosensitive member of the present invention.

FIG. 1C is a schematic sectional view of the electrophotographic photosensitive member of the present invention.

FIG. 1D is a schematic sectional view of the electrophotographic photosensitive member of the present invention.

FIG. 2 is a schematic sectional view of an electrophotographic apparatus of the present invention.

FIG. 3 is a film-forming apparatus capable of producing the electrophotographic photosensitive member of the present invention.

FIG. 4 is a schematic view of a chart used in the evaluation of an image memory.

### DESCRIPTION OF THE EMBODIMENTS

Preferred embodiments of the present invention will now be described in detail in accordance with the accompanying drawings.

The inventors of the present invention have made extensive studies with a view to realizing an electrophotographic photosensitive member that is excellent in sensitivity characteristic and high-humidity deletion resistance, has a high image-resolving power, and is suppressed in image memory even in a construction in which a hydrogenated amorphous silicon carbide (a-SiC) surface layer is laminated to have a large thickness for the purpose of lengthening the lifetime of the electrophotographic photosensitive member. As a result of their studies, the inventors have found that the control of the characteristics of the surface layer is mainly important for any such performance.

Hereinafter, the atom density of silicon atoms is sometimes referred to as “Si atom density”. In addition, the atom density of carbon atoms is sometimes referred to as “C atom density”. In addition, the sum of the atom density of the silicon atoms and the atom density of the carbon atoms is sometimes referred to as “Si+C atom density”.

(Electrophotographic Photosensitive Member of the Present Invention)

First, the layer construction of an electrophotographic photosensitive member of the present invention is described.

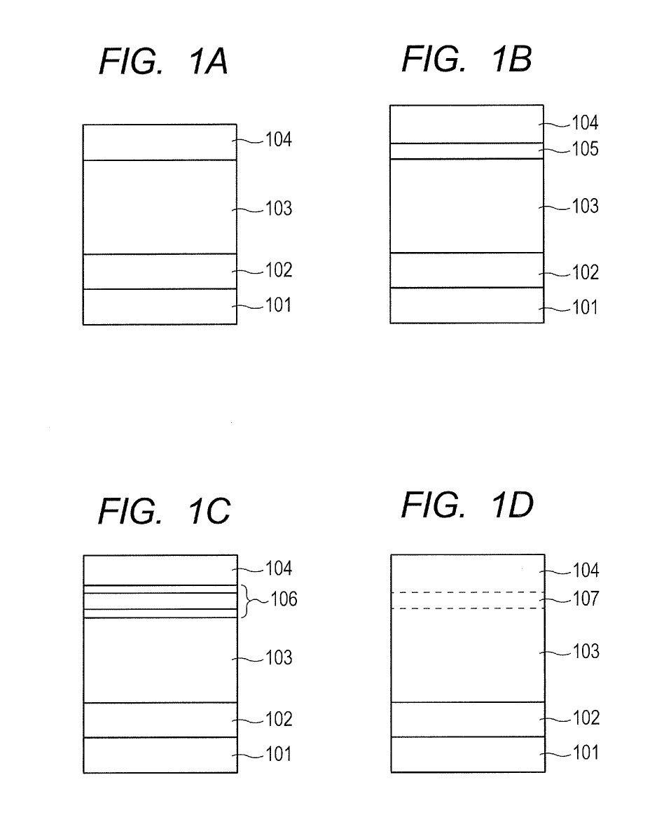

FIG. 1A is a schematic view illustrating the layer construction of an a-Si photosensitive member. A lower charge injection preventing layer 102, a photoconductive layer 103, and a surface layer 104 are sequentially laminated on a substrate 101. The layer construction is mainly applied to an a-Si photosensitive member for positive charging.

FIG. 1B is a schematic view illustrating the layer construction of an a-Si photosensitive member obtained by forming an intermediate layer 105 between the photoconductive layer 103 and the surface layer 104. The layer construction can also be applied to an a-Si photosensitive member for negative charging by imparting a charge injection preventing ability to the intermediate layer 105.

FIG. 1C is a schematic view illustrating the layer construction of an a-Si photosensitive member obtained by forming multiple intermediate layers 106 between the photoconductive layer 103 and the surface layer 104. The layer construction can also be applied to an a-Si photosensitive member for negative charging by imparting a charge injection preventing ability to any one of the multiple intermediate layers 106.

FIG. 1D is a schematic view illustrating the layer construction of an a-Si photosensitive member obtained by forming a change layer 107 between the photoconductive layer 103 and the surface layer 104. The layer construction can also be applied to an a-Si photosensitive member for negative charging by imparting a charge injection preventing ability to a part of the change layer 107.

Next, the respective layers and substrate constituting the photosensitive member with any such layer construction are described.

(Surface Layer)

The surface layer can obtain the above-mentioned effect by satisfying the following requirements: the ratio (C/(Si+C)) of the number of the carbon atoms (C) to the sum of the number of the silicon atoms (Si) and the number of the carbon atoms (C) in the a-SiC surface layer is set to 0.50 or more and 0.65 or less; the sum of the atom density of the silicon atoms and the atom density of the carbon atoms in the surface layer is set to 6.60×10²² atoms/cm³ or more; and the defect density of the surface layer determined by electron spin resonance measurement is set to 9.0×10¹⁸ spins/cm³ or sore and 2.2×10¹⁹ spins/cm³ or less.

First, increasing the light permeability of the a-SiC surface layer to increase the quantity of light that reaches the photoconductive layer is important for improving the sensitivity characteristic of the photosensitive member. To this end, the ratio C/(Si+C) of the a-SiC constituting the surface layer is set to fall within the range of 0.50 or more and 0.65 or less. Thus, the optical band gap of the a-SiC surface layer widens and hence the light permeability can be increased. In particular, the ratio C/(Si+C) is more preferably set to fall within the range of 0.55 or more and 0.63 or less.

Next, when the a-SiC surface layer is repeatedly charged upon image output, its outermost surface is oxidized to produce a polar group. The production of the polar group increases the adsorption amount of moisture because the production increases the surface free energy of the layer. The moisture that has adsorbed to the surface reduces the surface resistance of the layer, with the result that high-humidity deletion occurs. In other words, suppressing the oxidation of the a-SiC surface layer is effective in improving the high-humidity deletion resistance.

The sum of the atom density of the silicon atoms and the atom density of the carbon atoms in the a-SiC surface layer is set to 6.60×10²² atoms/cm³ or more in order that the oxidation of the a-SiC surface layer may be suppressed. Thus, a bonding force between a silicon atom and a carbon atom forming the skeleton of the a-SiC surface layer strengthens, whereby the oxidation resistance of the layer improves.

In addition, according to the defect density of the a-SiC surface layer, the resistivity of the a-SiC surface layer changes to affect an image resolution. When the defect density of the a-SiC surface layer increases, the resistivity reduces. When the resistivity extremely reduces, the charge forming a latent image drifts, which is responsible for image blurring. On the other hand, when the defect density of the a-SiC surface layer becomes extremely small, the resistivity increases. When the resistivity extremely increases, in the case where the thickness of the surface layer is made large, the resistance of the surface layer remarkably increases, which is responsible for an image memory. In other words, the defect density needs to be set to fall within a proper range for achieving compatibility between a high image resolution and the suppression of the image memory.

Further, when the photosensitive member including the a-SiC surface layer is applied to an electrophotographic apparatus adopting a two-component development system, the defect density of the a-SiC surface layer not only affects the resistivity of the surface layer but also is responsible for the occurrence of charge injection in a developing step. As the defect density of the a-SiC surface layer increases, the charge injection from a developing sleeve to the photosensitive member through a magnetic carrier particle increases in extent to be responsible for image blurring. The phenomenon is expected to occur not only in the two-component development system involving using the magnetic carrier particle but also in, for example, a liquid development system involving using a carrier liquid in a liquid state.

As a result of their studies, the inventors of the present invention have found that the problems can be solved by controlling the defect density of the a-SiC surface layer determined by electron spin resonance measurement to 9.0×10¹⁸ spins/cm³ or more and 2.2×10¹⁹ spins/cm³ or less. In particular, the range of 1.1×10¹⁹ spins/cm³ or more and 1.8×10¹⁹ spins/cm³ or less has been more preferred.

In addition, from the viewpoint of the high-humidity deletion resistance, a more preferred range of the ratio a₂/a₁ of an absorbance a₁ at a wave number of 2,960 cm⁻¹ to an absorbance a₁ at a wave number of 2,890 cm⁻¹ in an infrared absorption spectrum of the a-SiC surface layer is 0.52 or less. Absorption at a wave number of 2,960 cm⁻¹ in the infrared absorption spectrum is a peak resulting from absorption by sp³-CH₃ and absorption at a wave number of 2,890 cm⁻¹ therein is a peak resulting from absorption by sp³-CH. The foregoing means that the a-SiC surface layer contains a larger amount of a methyl group as the ratio a₂/a₁ increases.

In an a-SiC surface layer having a low Si+C atom density, the amount of a CH₂ chain or a methyl group tends to increase; provided that even when a-SiC surface layers have the same Si+C atom density, the layers may be different from each other in density of the CH₂ chain or the methyl group.

In particular, a state where the amount of a methyl group in the a-SiC surface layer increases means that a network between a silicon atom and a carbon atom is locally broken. In view of the foregoing, the ratio a₂/a₁ is controlled to be low while the Si+C atom density is set to 6.60+10²² atoms/cm³ or more. Thus, local formation of a weak portion in the network between a silicon atom and a carbon atom in the a-SiC surface layer is inhibited. As a result of the foregoing, the skeleton of the a-SiC becomes additionally tough and the high-humidity deletion resistance improves. Of course, a bonding state between a silicon atom and a hydrogen atom also affects the skeleton of the a-SiC.

In actuality, however, the amount of a C—H bond tends to be larger than that of an Si—H bond because the energies of the C—H bond and the Si—H bond are 98.8 (kcal/mol) and 70.4 (kcal/mol), respectively. In other words, a change in manner in which a hydrogen atom is taken in the a-SiC surface layer significantly appears in the C—H bond. Accordingly, in the present invention, attention has been paid to the state of a hydrogen atom bonded to a carbon atom, and the more preferred range of the ratio a₂/a₁ of the accordance a₂ at a wave number of 2,960 cm⁻¹ to the absorbance a₁ at a wave number of 2,890 cm⁻¹ in the infrared absorption spectrum is 0.52 or less.

(Intermediate Layer)

In the present invention in which the light permeability of the a-SiC surface layer has been increased, an intermediate layer comprising (formed of) an a-SiC is preferably formed between the a-SiC surface layer and the photoconductive layer.

In the present invention, in order that the light permeability may be increased, the ratio C/(Si+C) is set to fall within the range of 0.50 or more and 0.65 or less, and the optical band gap of the a-SiC surface layer is set to be wide. That is, a difference in optical band gap between the surface layer and the photoconductive layer enlarges unless the band gap of the photoconductive layer is changed. When the difference in optical band gap enlarges, band unconformity enlarges, with the result that the transfer of charge between the surface layer and the photoconductive layer is no longer smooth.

For example, when a photocarrier produced in the photoconductive layer by exposure is trapped on the side of an interface between the surface layer and the photoconductive layer closer to the photoconductive layer, the following case is conceivable: the resistance of the photoconductive layer is low and hence the photocarrier drifts to cause image blurring.

In such case, the formation of an intermediate layer in which the composition of the a-SiC has been optimized can facilitate the transfer of the photocarrier produced by exposure to the surface layer. Thus, the problems can be solved. To this end, the ratio (C/(Si+C)) of the a-SiC intermediate layer is set to be lower than the ratio (C/(Si+C)) of the a-SiC surface layer.

Of course, the a-SiC intermediate layer may be provided with multiple layers in which the ratio (C/(Si+C)) is changed in a stepwise manner, or the ratio (C/(Si+C)) of the a-SiC intermediate layer may be continuously changed. In this case, the following construction is preferred: the ratio (C/(Si+C)) of the a-SiC intermediate layer monotonically increases from the photoconductive layer toward the a-SiC surface layer. The expression “monotonically increases” means that a region where the ratio (C/(Si+C)) substantially reduces from the photoconductive layer to the surface layer is absent.

In addition, in the case of a photosensitive member for negative charging, imparting a charge injection preventing ability to the intermediate layer is effective in obtaining a charging characteristic. Incorporating an atom belonging to Group 13 in the periodic table into the a-SiC intermediate layer is effective in improving the charge injection preventing ability. Of the atoms belonging to Group 13 in the periodic table, a boron atom, an aluminum atom, or a gallium atom is preferred. It should be noted that the intermediate layer to which the charge injection preventing ability has been imparted is hereinafter sometimes referred to as “upper preventing layer”.

(Photoconductive Layer)

In the present invention, the photoconductive layer may be any layer as long as the layer has a photoconductive characteristic capable of satisfying performance in terms of an electrophotographic characteristic. However, an a-Si photoconductive layer is preferred from the viewpoints of durability and stability.

In the present invention, when a photoconductive layer comprising (formed of) an a-Si is used as the photoconductive layer, a halogen atom as well as a hydrogen atom can be incorporated to compensate a dangling hand in the a-Si.

The total content (H+X) of hydrogen atoms (H) and halogen atoms (X) is preferably 10 atom % or more, more preferably 15 atom % or more with respect to the sum (Si+H+X) of silicon atoms (Si), the hydrogen atoms (H) and the halogen atoms (X). Meanwhile, the total content is preferably 30 atom % or less, more preferably 25 atom % or less.

In the present invention, an atom for conductivity control is preferably incorporated into the photoconductive layer as required. The atoms for conductivity control may be evenly incorporated into the photoconductive layer in a uniformly distributed state. Alternatively, a portion where the atoms are incorporated in a nonuniformly distributed state may be present along the thickness direction of the layer.

Examples of the atom for conductivity control can include the so-called impurities in a semiconductor field. That is, an atom belonging to Group 13 in the periodic table that imparts p-type conductivity or an atom belonging to Group 15 in the periodic table that imparts n-type conductivity can be used. Of the atoms belonging to Group 13 in the periodic table, a boron atom, an aluminum atom, or a gallium atom is preferred. Of the atoms belonging to Group 15 in the periodic table, a phosphorus atom or an arsenic atom is preferred.

The content of the atoms for conductivity control to be incorporated into the photoconductive layer is preferably 1×10⁻² atomic ppm or more with respect to the silicon atoms (Si). Meanwhile, the content is preferably 1×10² atomic ppm or less.

In the present invention, the thickness of the photoconductive layer is preferably 15 μm or more and 60 μm or less in terms of, for example, an electrophotographic characteristic and a cost. When the thickness of the photoconductive layer is 15 μm or more, the quantity of a passing current for a charging member hardly increases and hence the electrophotographic photosensitive member hardly deteriorates.

When the thickness of the photoconductive layer is 60 μm or less, an abnormally grown site of the a-Si (such as a site ranging from 50 μm or more to 150 μm or less in a horizontal direction and from 5 μm or more to 20 μm or less in a height direction) hardly enlarges, damage to a member for rubbing the surface of the layer is suppressed, and the occurrence of an image defect is suppressed.

It should be noted that the photoconductive layer may be formed of a single layer, or may be formed of multiple layers (such as a charge-generating layer and a charge-transporting layer).

(Lower Charge Injection Preventing Layer)

In the present invention, a charge injection preventing layer having a function of preventing the injection of charge from a substrate side is preferably formed between the substrate and the photoconductive layer. It should be noted that the lower charge injection preventing layer is hereinafter sometimes referred to as “lower preventing layer”. The lower preventing layer is a layer having a function of preventing the injection of charge from the substrate to the photoconductive layer when the surface of the photosensitive member is subjected to a charging treatment of certain polarity. In order that such function may be imparted, an atom for conductivity control is incorporated into the lower preventing layer in a larger amount than that of the photoconductive layer while the lower preventing layer is based on a material constituting the photoconductive layer.

The atoms to be incorporated into the lower preventing layer for controlling conductivity may be evenly incorporated into the lower preventing layer in a uniformly distributed state. Alternatively, a portion where the atoms are incorporated in a nonuniformly distributed state may be present along the thickness direction of the layer. When the concentration distribution is nonuniform, the atoms are suitably incorporated so as to be distributed in a large amount on the substrate side. In all cases, the atoms for conductivity control are preferably incorporated into the lower preventing layer so as to have a uniform distribution in an in-plane direction parallel to the surface of the substrate in order that the uniformization of a characteristic may be achieved.

An atom belonging to Group 13 or 15 in the periodic table can be used as the atom to be incorporated into the lower preventing layer for controlling conductivity according to the charging polarity.

Further, incorporating at least one kind of atom out of a carbon atom, a nitrogen atom, and an oxygen atom into the lower preventing layer can improve adhesiveness between the lower preventing layer and the substrate.

The atoms of at least one kind out of a carbon atom, a nitrogen atom, and an oxygen atom to be incorporated into the lower preventing layer may be evenly incorporated into the lower preventing layer in a uniformly distributed state. Alternatively, a portion where the atoms are uniformly incorporated along the thickness direction of the layer but are incorporated in a nonuniformly distributed state may be present. In all cases, the atoms for conductivity control are preferably incorporated into the charge injection preventing layer so as to have a uniform distribution in the in-plane direction parallel to the surface of the substrate in order that the uniformization of a characteristic may be achieved.

The thickness of the lower preventing layer is preferably 0.1 μm or more and 10 μm or less, more preferably 0.3 μm or more and 5 μm or less in terms of an electrophotographic characteristic and a cost. When the thickness is set to 0.1 μm or more, the layer can sufficiently have an ability to prevent the injection of charge from the substrate and can obtain a preferred charging ability. Meanwhile, when the thickness is set to 5 μm or less, an increase in production cost resulting from the extension of the formation time of the lower preventing layer can be suppressed.

(Substrate)

The substrate is preferably a substrate having conductivity (electro-conductive substrate), and is preferably capable of holding the photoconductive layer and surface layer to be formed on its surface. A material for the substrate is, for example, a metal such as aluminum or iron, or an alloy thereof. It should be noted that the substrate having conductivity (electro-conductive substrate) is hereinafter sometimes referred to as “conductive substrate”.

(Electrophotographic Apparatus Including the Electrophotographic Photosensitive Member of the Present Invention)

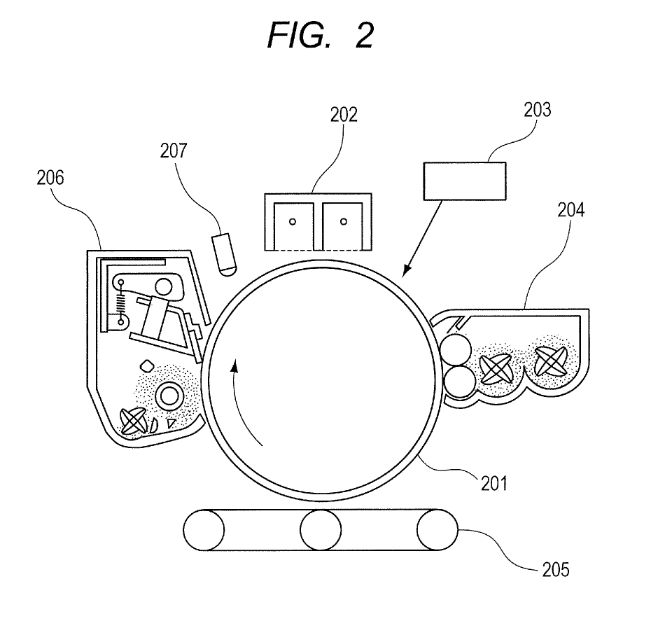

An image-forming method based on an electrophotographic apparatus including an a-Si photosensitive member is described with reference to FIG. 2.

First, a photosensitive member 201 is rotated and the surface of the photosensitive member 201 is uniformly charged by a main charger (charging device) 202. After that, an electrostatic latent image is formed on the surface of the photosensitive member 201 by irradiating the surface of the photosensitive member 201 with image exposure light from an electrostatic latent image-forming device (exposing device) 203. After that, the electrostatic latent image is developed with toner supplied from a developing unit (developing device) 204. As a result, a toner image is formed on the surface of the photosensitive member 201.

Then, the toner image is transferred onto an intermediate transfer member 205 as an example of a transferring device and then secondarily transferred from the intermediate transfer member 205 onto a transfer material (not shown) such as paper, followed by the fixation of the toner image on the transfer material by a fixing device (not shown).

Meanwhile, the toner remaining on the surface of the photosensitive member 201 from which the toner image has been transferred is removed by a cleaner (cleaning device) 206. After that, the surface of the photosensitive member 201 is exposed by a pre-exposing unit 207. Thus, a carrier remaining in the photosensitive member 201 at the time of the formation of the electrostatic latent image is discharged. Image formation is continuously performed by repeating the series of such processes.

(Production Apparatus and Production Method for Producing the Electrophotographic Photosensitive Member of the Present Invention)

Any method may be used as the production method for an electrophotographic photosensitive member of the present invention as long as the method can form a layer that satisfies the above-mentioned definition. Specific examples thereof include a plasma CVD method, a vacuum deposition method, a sputtering method, and an ion plating method. Of those methods, a plasma CVD method is preferred from the viewpoint of ease in material supply.

Hereinafter, a production apparatus and a production method each employing a plasma CVD method are described.

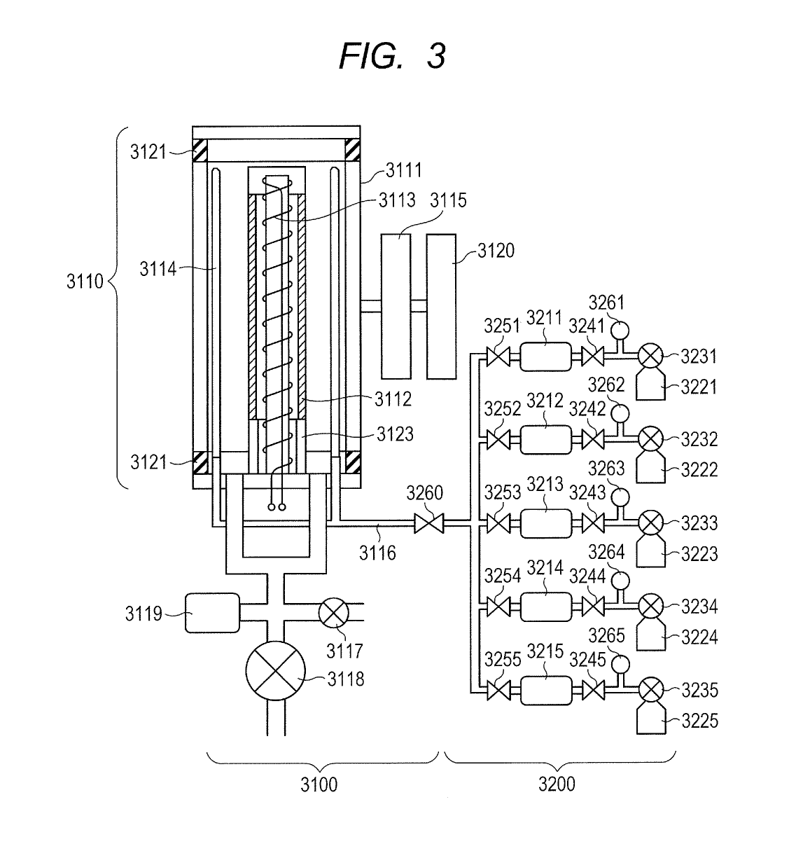

FIG. 3 is a view schematically illustrating an example of a deposition apparatus for a photosensitive member based on an RF plasma CVD method, the apparatus using a high-frequency power source, for producing the a-Si photosensitive member of the present invention.

The deposition apparatus mainly includes a deposition apparatus 3100 including a reaction vessel 3110, a raw material gas-supplying apparatus 3200, and an exhaust apparatus (not shown) for reducing a pressure in the reaction vessel 3110.

A substrate 3112 connected to the ground, a heater 3113 for heating the substrate, and a raw material gas-introducing pipe 3114 are placed in the reaction vessel 3110 in the deposition apparatus 3100. Further, a high-frequency power source 3120 is connected to a cathode electrode 3111 through a high-frequency matching box 3115.

The raw material gas-supplying apparatus 3200 includes raw material gas bombs 3221 to 3225, valves 3231 to 3235, pressure regulators 3261 to 3265, inflow valves 3241 to 3245, outflow valves 3251 to 3255, and mass flow controllers 3211 to 3215. The gas bombs having encapsulated therein respective raw material gases are connected to the raw material gas-introducing pipe 3114 in the reaction vessel 3110 through an auxiliary valve 3260. Reference numeral 3116 represents a gas piping, reference numeral 3117 represents a leak valve, and reference numeral 3121 represents an insulating material.

Next, a method of forming a deposited film involving using the apparatus is described. First, the substrate 3112 subjected to degreasing and washing in advance is placed in the reaction vessel 3110 through a cradle 3123. Next, the exhaust apparatus (not shown) is operated to exhaust the inside of the reaction vessel 3110. The display of a vacuum meter 3119 is viewed, and at the time when the pressure in the reaction vessel 3110 reaches a predetermined pressure, e.g., 1 Pa or less, an electric power is supplied to the heater 3113 for heating the substrate to heat the substrate 3112 to a predetermined temperature, e.g., 50° C. or more and 350° C. or less. At this time, the heating can be performed in an inert gas atmosphere by supplying an inert gas such as Ar or He from the gas-supplying apparatus 3200 to the reaction vessel 3110.

Next, a gas to be used in the formation of a deposited film is supplied from the gas-supplying apparatus 3200 to the reaction vessel 3110. That is, the valves 3231 to 3235, the inflow valves 3241 to 3245, and the outflow valves 3251 to 3255 are opened as required to set the flow rates of the mass flow controllers 3211 to 3215. When the flow rate of each mass flow controller stabilizes, the pressure in the reaction vessel 3110 is adjusted to a desired pressure by operating a main valve 3118 while viewing the display of the vacuum meter 3119.

When the desired pressure is obtained, a high-frequency power is applied from the high-frequency power source 3120, and at the same time, the high-frequency matching box 3115 is operated to cause plasma discharge in the reaction vessel 3110. After that, the high-frequency power is immediately adjusted to a desired electric power and the formation of the deposited film is performed.

After the completion of the formation of the predetermined deposited film, the application of the high-frequency power is stopped, and the valves 3231 to 3235, the inflow valves 3241 to 3245, the outflow valves 3251 to 3255, and the auxiliary valve 3260 are closed to terminate the supply of the raw material gases. At the same time, the main, valve 3118 is fully opened to exhaust the inside of the reaction vessel 3110 to a pressure of, for example, 1 Pa or less.

Thus, the formation of the deposited film ends. However, when multiple deposited films are formed, each layer has only to be formed by repeating the procedure again. A joining region can be formed by changing, for example, the pressure and the flow rate of a raw material gas to conditions at the time of the formation of the photoconductive layer over a certain time period.

After the completion of the formation of all deposited films, the main valve 3118 is closed and an inert gas is introduced into the reaction vessel 3110 to return the pressure therein to the atmospheric pressure. After that, the substrate 3112 is taken out.

In the formation of the a-SiC surface layer, as a raw material gas for supplying a silicone atom, there may suitably be used, for example, silanes such as silane (SiH₄) and disilane (Si₂H₆). In addition, as a raw material gas for supplying a carbon atom, there may suitably be used, for example, gases such as methane (CH₄) or acetylene (C₂H₂). The ratio (C/(Si+C)) of a-SiC can be adjusted through adjustment of mixing ratio of those raw material gases.

It should be noted that in the formation of the a-SiC surface layer of the present invention, hydrogen (H₂) dilution has been a useful method for adjusting the Si+C atom density and the defect density. When the raw material gases are diluted with hydrogen, the amount of hydrogen atoms to be incorporated into the formed a-SiC surface layer largely reduces once and then slightly increases. In a region where the amount of the hydrogen atoms to be incorporated into the a-SiC surface layer reduces, the Si+C atom density increases according to the reduction of the amount of the hydrogen atoms to be incorporated into the a-SiC surface layer.

Further, in a region where the amount of dilution with hydrogen atoms (hereinafter sometimes referred to as “hydrogen dilution amount”) is increased to slightly increase the amount of the hydrogen atoms to be incorporated into the a-SiC surface layer, the defect density reduces in association with the slight increase of the amount of the hydrogen atoms to be incorporated into the a-SiC surface layer. In other words, the optimization of the hydrogen dilution amount enables the control of the Si+ C atom density and the defect density.

It should be noted that other parameters enabling the increase of the Si+C atom density are, for example, to reduce the flow rate of a raw material gas, to increase the high-frequency power, and to increase the temperature of the substrate. Meanwhile, the defect density can be reduced by increasing the pressure in the reaction vessel (hereinafter sometimes referred to as “reaction pressure”). Setting has only to be performed by appropriately combining those conditions.

The same method as that in the case of the formation of the surface layer can be adopted for the formation of the intermediate layer. In addition, the intermediate layer is formed by setting conditions such as the amounts of the raw material gases and the like to be supplied to the reaction vessel, the high-frequency power, the reaction pressure, and the temperature of the substrate as required. It should be noted that the intermediate layer has only to be formed by adding a raw material gas containing an atom belonging to Group 13 or 15 in the periodic table according to the charging polarity in order that a charge injection preventing ability may be imparted to the intermediate layer. Examples of the raw material gas containing an atom belonging to Group 13 or 15 in the periodic table include phosphine (PH₃) and diborane (B₂H₆).

In the formation of the photoconductive layer, silanes such as silane (SiH₄) and disilane (Si₂H₆) can each be suitably used as a raw material gas for supplying a silicon atom. In addition, for example, hydrogen (H₂) as well as the silanes can be suitably used as a raw material gas for supplying a hydrogen atom.

In addition, when such halogen atom, atom for conductivity control, carbon atom, oxygen atom, nitrogen atom, or the like as described above is incorporated into the photoconductive layer, a substance containing any such atom that is gaseous or can easily gasify has only to be appropriately used as a material.

Hereinafter, the present invention is described in more detail by way of Examples and Comparative Examples. However, the present invention is by no means limited by these examples.

### Example 1 and Comparative Example 1

A lower preventing layer, a photoconductive layer, an upper preventing layer, and a surface layer were sequentially formed on a cylindrical substrate with a plasma treatment apparatus of FIG. 3 under conditions shown in Table 1 below to produce each a-Si photosensitive member for negative charging. A cylindrical conductive substrate made of aluminum subjected to mirror finishing with a diameter of 84 mm, a length of 371 mm, and a thickness of 3 mm was used as the cylindrical substrate.

It should be noted that the flow rates of raw material gases, reaction pressure, high-frequency power, and temperature of the substrate (substrate temperature) at the time of the formation of the surface layer were set to conditions shown in Table 2 below. Two photosensitive members were produced for each film-forming condition (layer-forming condition). In addition, one reference photosensitive member having formed therein only the lower preventing layer, photoconductive layer, and upper preventing layer of Table 1 was produced.

TABLE 1

| | Lower | | Intermediate layer | |
|---|---|---|---|---|
| | preventing | Photoconductive | (upper preventing | Surface |
| | layer | layer | layer) | layer |
| Kind and flow rate of gas | | | | |
| SiH₄ [mL/min (normal)] | 350 | 450 | 250 | * |
| H₂ [mL/min (normal)] | 750 | 2,200 | | * |
| B₂H₆ [ppm] (with respect to | | | 150 | |
| SiH₄) | | | | |
| NO [mL/min (normal)] | 10 | | | |
| CH₄ [mL/min (normal)] | 700 | | 250 | * |
| Reaction pressure [Pa] | 40 | 80 | 40 | * |
| High-frequency power [W] | 400 | 800 | 400 | * |
| Substrate temperature [° C.] | 260 | 220 | 260 | * |
| Thickness [μm] | 3 | 25 | 0.2 | 1 |

TABLE 2

| | Film-forming condition No. | | | | | | |
|---|---|---|---|---|---|---|---|
| | 1 | 2 | 3 | 4 | 5 | 6 | 7 |
| Kind and flow rate of gas | | | | | | | |
| SiH₄ [mL/min (normal)] | 35 | 29 | 24 | 19 | 16 | 15 | 11 |
| H₂ [mL/min (normal)] | 1,700 | 1,700 | 1,700 | 1,700 | 1,700 | 1,700 | 1,700 |
| CH₄ [mL/min (normal)] | 165 | 171 | 176 | 181 | 184 | 185 | 189 |
| Reaction pressure [Pa] | 80 | 80 | 80 | 80 | 80 | 80 | 80 |
| High-frequency power [W] | 400 | 400 | 400 | 400 | 400 | 400 | 400 |
| Substrate temperature [° C.] | 260 | 260 | 260 | 260 | 260 | 260 | 260 |

The Si atom density, C atom density, Si+C atom density, ratio (C/(Si+C)), and defect density of one photosensitive member for each film-forming condition produced in each of Example 1 and Comparative Example 1 were determined by analysis methods to be described later. In addition, the ratio a₂/a₁ of the absorbance a₂ at a wave number of 2,960 cm⁻¹ to the absorbance a₁ at a wave number of 2,890 cm⁻¹ in an infrared absorption spectrum was determined by an analysis method to be described later.

Meanwhile, the other photosensitive member for each film-forming condition was evaluated for its sensitivity characteristic, high-humidity deletion resistance, image-resolving power 1, and image memory under evaluation conditions to be described later by methods to be described later. Table 3 shows the results of the evaluations of Example 1 and Comparative Example 1.

(Measurement of Thickness of Surface Layer)

First, a reference sample was produced, by cutting a square 15 mm from a central portion of a longitudinal direction in an arbitrary circumferential direction of the reference photosensitive member.

Next, a sample for measurement was produced by similarly cutting a square from the photosensitive member having formed therein the lower preventing layer, the photoconductive layer, the upper preventing layer, and the surface layer.

The thickness of the surface layer of each of the reference sample and the sample for measurement was determined by measurement based on spectroscopic ellipsometry (manufactured by J.A. Woollam Co., Inc.: High-speed Spectroscopic Ellipsometry M-2000).

Specific measurement conditions for spectroscopic ellipsometry were as follows: an incident angle of 60°, 65°, or 70°, a measurement wavelength of 195 nm to 700 nm, and a beam diameter of 1 mm×2 mm.

First, the relationship between a wavelength, and an amplitude ratio Ψ and a phase difference Δ of the reference sample was determined by spectroscopic ellipsometry at each incident angle.

Next, the relationship between the wavelength, and the amplitude ratio Ψ and the phase difference Δ of the sample for measurement was determined by spectroscopic ellipsometry at each incident angle in the same manner as in the reference sample with reference to the result of the measurement of the reference sample.

Further, the lower preventing layer, the photoconductive layer, the upper preventing layer, and the surface layer were sequentially formed. Then, the relationship between the wavelength, and the amplitude ratio Ψ and the phase difference Δ at each angle of incidence was determined through calculation by using, as a calculation model, a layer construction having a roughness layer, in which the surface layer and an air layer coexisted on its outermost surface, and by changing a volume ratio between the surface layer and the air layer of the roughness layer with an analysis software. Then, a calculation model when a mean square error between: the relationship between the wavelength, and the amplitude ratio Ψ and the phase difference Δ determined by the calculation; and the relationship between the wavelength, and the amplitude ratio Ψ and the phase difference Δ determined by the measurement of the sample for measurement at each incident angle were minimized was selected.

The thickness of the surface layer was calculated with the selected calculation model and the resultant value was defined as the thickness of the surface layer. It should be noted that a WVASE32 manufactured by J.A. Woollam Co., Inc. was used as the analysis software. In addition, the calculation was performed by changing the ratio of the air layer of the roughness layer from a ratio “surface layer:air layer” of 10:0 to 1:9 by 1 in terms of the volume ratio between the surface layer and the air layer of the roughness layer.

In the a-Si photosensitive member for positive charging produced under each film-forming condition of the examples, when the volume ratio between the surface layer and the air layer of the roughness layer was 8:2, the mean square error between: the relationship between the wavelength, and the amplitude ratio Ψ and the phase difference Δ determined by the calculation; and the relationship between the wavelength, and the amplitude ratio Ψ and the phase difference Δ determined by the measurement were minimized.

(Measurement of Ratio (C/(Si+C>) and Si+C Atom Density)

After the completion of the measurement based on spectroscopic ellipsometry, the sample for measurement was measured for the numbers of silicon atoms and carbon atoms in its surface layer in an area subjected to measurement by Rutherford backscattering spectrometry (RBS) with the following apparatus.

Backscattering measuring apparatus: AN-2500 manufactured by NHV Corporation

The ratio (C/(Si+C)) was determined from the measured numbers of the silicon atoms and the carbon atoms. Next, the Si atom density, the C atom density, and the Si+C atom density were determined by using the thickness of the surface layer determined by spectroscopic ellipsometry relative to the numbers of the silicon atoms and the carbon atoms determined from the area subjected to measurement by RBS.

It should be noted that the ratio (C/(Si+ C)) of the intermediate layer was subjected to analysis in a depth direction by the simulation analysis of the result of the measurement by RBS.

Specific measurement conditions for RBS were as follows: an incident ion of ⁴He⁺, an incident energy of 2.3 MeV, an incident angle of 75°, a sample current of 35 nA, and an incident beam diameter of 1 mm. In addition, the measurement was performed with the following detectors: a detector for RBS had a scattering angle of 160° and an aperture diameter of 8 mm, and a detector for HFS had a recoil angle of 30° and an aperture diameter of 8 mm+Slit.

(Measurement of Defect Density)

The defect density of the a-SiC surface layer was measured by an electron spin resonance (ESR) method with the following apparatus.

Main Apparatus: ELEXSYS E580 manufactured by Bruker,
Gaussmeter: ER036TM manufactured by Bruker,
Cryostat: ESR900 manufactured by Oxford Instruments.

A strip (measuring 20 mm by 3 mm) cut out of the central portion in the longitudinal direction in an arbitrary circumferential direction of the photosensitive member was defined as a sample for measurement and subjected to ESR measurement under the following conditions.

A reference sample was similarly cut out of the reference photosensitive member. The reference sample was similarly subjected to ESR measurement, and the number of defects resulting from the surface layer was calculated from a difference between the sample for measurement and the reference sample. It should be noted that the defect density (spin density) of the a-SIC surface layer was calculated from a signal (g value=around 2.0020 to 2.0030) considered to result mainly from a dangling bond on C. The defect density was determined by using the thickness of the surface layer determined by spectroscopic ellipsometry relative to the number of defects determined from an area subjected to the ESR measurement.

Specific measurement conditions for the ESR method were as follows: measurement temperature: 30 K, central magnetic field: 3,369 G, range of magnetic field sweep: 200 G, modulation: 100 kHz, 20 G, microwave: 9.43 GHz, 2 μW, sweep time: 83.886 s×10 times, a time constant: 163.84 ms, a number of data points: 1,024 points, and cavity: TE011, cylinder type.

(FT-IR-ATR Method)

A functional group of the a-SiC surface layer was subjected to measurement by a Fourier-transform infrared spectroscopy-attenuated total reflection (FT-IR-ATR) method with the following apparatus.

Manufactured by Bio-Rad Digilab: FT-IR Apparatus FTS-55A

A square 15 mm cut out of the central portion of the longitudinal direction in an arbitrary circumferential direction of the photosensitive member was defined as a measurement sample and subjected to FT-IR-ATR measurement under the following conditions.

Specific measurement conditions for the FT-IR-ATR method were set as follows: light source: special ceramics, detector: HgCdTe, resolution: 4 cm⁻¹, cumulative number: 256 times, IRE: Ge, incident angle: 60°, attachment: attachment for one-time reflection ATR (Seagull).

It should be noted that when the refractive index of the a-SiC surface layer is set to 1.9 to 2.5 under the conditions, the measuring depth of the ATR method is 0.2 μm at maximum at 2,000 cm⁻¹. Accordingly, the influence of a layer below the a-SIC surface layer can be ignored by laminating the a-SiC surface layer so that the a-SiC surface layer may have a thickness of 0.3 μm or more.

The ratio a₂/a₁ of the absorbance a₂ at a wave number of 2,960 cm⁻¹ to the absorbance a₁ at a wave number of 2,890 cm⁻¹ was determined by performing the baseline correction of a measured waveform.

(Sensitivity Characteristic)

A reconstructed machine of a digital electrophotographic apparatus “image RUNNER ADVANCE C7065” (trade name) manufactured by Canon Inc. was used in an evaluation for a sensitivity characteristic. The reconstructed machine was of such a construction that primary charging and a developing bias were applied from an external power source.

The produced photosensitive member was mounted on the Bk station of the digital electrophotographic apparatus “image RUNNER ADVANCE C7065”. The grid voltage and the primary current of the primary charging were set by adjusting a wire and a grid so that the dark portion surface potential of the photosensitive member became 500 V. Next, the photosensitive member in a state of being charged under the previously set charging condition was irradiated with image exposure light, and an electric potential at a developing unit position was set to 150 V by adjusting its irradiation energy.

The results of the evaluation were shown as values relative to the case where the irradiation energy when the photosensitive member of Comparative Example 4-3 was mounted was defined as 1.00.

A . . . The ratio of the irradiation energy with respect to the irradiation energy in the photosensitive member produced in Comparative Example 4-3 is less than 0.90.

B . . . The ratio of the irradiation energy with respect to the irradiation energy in the photosensitive member produced in Comparative Example 4-3 is 0.90 or more and less than 0.95.

C . . . The ratio of the irradiation energy with respect to the irradiation energy in the photosensitive member produced in Comparative Example 4-3 is 0.95 or more.

(High-Humidity Deletion Resistance)

An evaluation for high-humidity deletion resistance is an evaluation for image deletion (durability deletion) after a durability test has been performed.

A reconstructed machine of a digital electrophotographic apparatus “image RUNNER ADVANCE 8105 Pro” (trade name) manufactured by Canon Inc. was used in the evaluation for high-humidity deletion resistance. The reconstructed machine was of such a construction that primary charging and a developing bias were applied from an external power source, and the DC component of each of the primary charging and the developing bias was changed to negative charging. In addition, a development process was changed to a reversal development process in which the exposed portion of the photosensitive member was reversed and the exposed portion of the photosensitive member was developed with toner.

The produced photosensitive member was placed in the electrophotographic apparatus, and an image of an A3 letter chart (4 pt, print percentage: 4%) before a continuous sheet-passing test was output under a high-humidity environment having a temperature of 25° C. and a relative humidity of 75% (volume absolute humidity: 17.3 g/cm³). At this time, the output was performed under the following condition: a photosensitive member heater was turned on.

After the image output before the continuous sheet-passing test, the continuous sheet-passing test was performed. The continuous sheet-passing test was performed under the following condition: the photosensitive member heater was always turned off during the time period for which the electrophotographic apparatus was operated to perform the continuous sheet-passing test and during the time period for which the electrophotographic apparatus was stopped.

Specifically, a continuous sheet-passing test of 25,000 sheets per day was performed with an A4 test pattern having a print percentage of 1% for 10 days. In other words, 250,000 sheets were subjected to the test. After the completion of the continuous sheet-passing test, the electrophotographic apparatus was left at rest under an environment having a temperature of 25° C. and a relative humidity of 75% for 15 hours.

After a lapse of 15 hours, the electrophotographic apparatus was operated while the photosensitive member heater was turned off, and the image of the A3 letter chart (4 pt, print percentage: 4%) was output. The image output before the continuous sheet-passing test and the image output after the continuous sheet-passing test were each digitised into a PDF file with the following digital electrophotographic apparatus under the binary conditions of monochromatic 300 dpi.

Digital electrophotographic apparatus: “image RUNNER ADVANCE 8105 Pro” (trade name) manufactured by Canon Inc.

The black ratio of the image region (measuring 251.3 mm by 273 mm) of each digitized image corresponding to one cycle of the photosensitive member was measured with an image-editing software “Adobe Photoshop” (trade name) manufactured by Adobe. Next, the evaluation for durability deletion was performed by determining the ratio of the black ratio of the image output after the continuous sheet-passing test to that of the image output before the continuous sheet-passing test.

When high-humidity deletion occurs, a letter blurs in an entire image or the letter is not printed and a blank dot occurs. Accordingly, the black ratio in the output image reduces as compared with the normal image before the continuous sheet-passing test. Accordingly, nigh-humidity deletion resistance becomes better as the ratio of the black ratio of the image output after the continuous sheet-passing test to that of the normal image before the continuous sheet-passing test becomes closer to 100%.

A . . . The ratio of the black ratio of the image output after the continuous sheet-passing test to that of the image before the continuous sheet-passing test is 90% or more and 110% or less.

B . . . The ratio of the black ratio of the image output after the continuous sheet-passing test to that of the image before the continuous sheet-passing test is 80% or more and less than 90%.

C . . . The ratio of the black ratio of the image output after the continuous sheet-passing test to that of the image before the continuous sheet-passing test is less than 80%.

(Image-Resolving Power 1)

A reconstructed machine of a digital electrophotographic apparatus “image RUNNER ADVANCE C7065” (trade name) manufactured by Canon Inc. was used in an evaluation for the image-resolving power 1. The reconstructed machine was of such a construction that primary charging and a developing bias could be applied from an external power source.

In addition, image data was constituted so as to be capable of being directly output without through any printer driver, and an area gradation image of an area gradation dot screen (i.e., the area gradation of a dot portion to be subjected to image exposure) was output by image exposure light at a linear density of 212 lpi at 45° (212 lines per inch). Gradation data uniformly distributed among 17 levels was used for the area gradation image. At this time, a number was assigned to each gradation as follows to provide gradation levels: 17 was assigned to the densest gradation and 0 was assigned to the palest gradation.

Next, the produced photosensitive member was placed in the reconstructed electrophotographic apparatus, and an image was output on A3 paper by using the gradation data and a text mode. In order for the influence of high-humidity deletion to be eliminated, the image was output under an environment having a temperature of 22° C. and a relative humidity of 50% while the photosensitive member heater was turned on and the surface of the photosensitive member was kept at about 40° C.

The image density of the resultant image was measured with a reflection densitometer (manufactured by X-Rite Inc.: 504 Spectral Densitometer) for each gradation. It should be noted that in the reflection density measurement, 3 images were output for each gradation and the average of their densities was defined as an evaluation value.

A correlation coefficient between the evaluation value thus obtained and the gradation level was calculated, and a difference from the correlation coefficient when such gradation representation that the reflection densities at the respective gradations changed in a completely linear manner was obtained, i.e. 1.00, was determined. Then, an evaluation was performed by using, as an indicator of the image-resolving power, the ratio of a difference calculated from the correlation coefficient of the photosensitive member produced under each film-forming condition to a difference calculated from the correlation coefficient of the photosensitive member produced in Comparative Example 3-3. In the evaluation, a smaller numerical value means that the image-resolving power is more excellent.

A . . . The ratio of the difference from a correlation coefficient of 1.00 calculated from the photosensitive member produced under each film-forming condition to the difference from a correlation coefficient of 1.00 calculated from the correlation coefficient of the photosensitive member produced in Comparative Example 3-3 is 1.50 or less.

B . . . The ratio of the difference from a correlation coefficient of 1.00 calculated from the photosensitive member produced under each film-forming condition to the difference from a correlation coefficient of 1.00 calculated from the correlation coefficient of the photosensitive member produced in Comparative Example 3-3 is more than 1.50 and 2.00 or less.

C . . . The ratio of the difference from a correlation coefficient of 1.00 calculated from the photosensitive member produced under each film-forming condition to the difference from a correlation coefficient of 1.00 calculated from the correlation coefficient of the photosensitive member produced in Comparative Example 3-3 is more than 2.00.

(Image Memory)

A reconstructed machine of a digital electrophotographic apparatus “image RUNNER ADVANCE C7065” (trade name) manufactured by Canon Inc. was used in an evaluation for the image memory. The reconstructed machine was of such a construction that primary charging and a developing bias could be applied from an external power source.

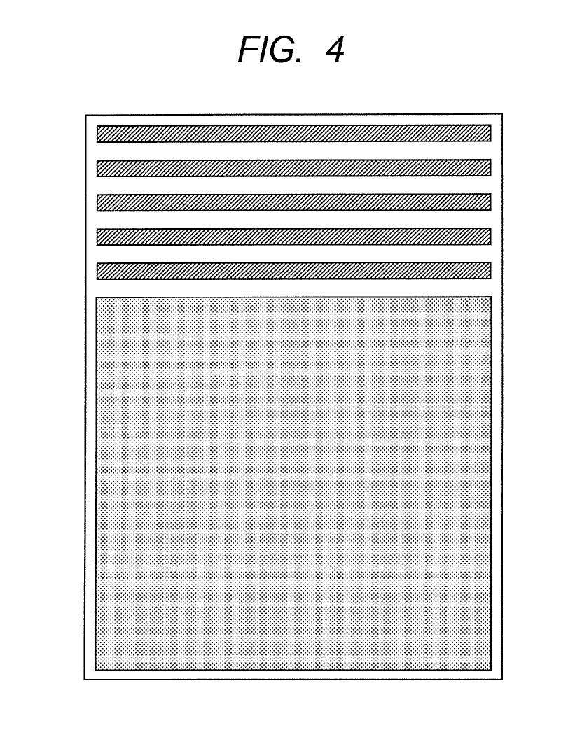

In addition, image data was constituted so as to be capable of being directly output without through any printer driver, and an A3 test chart illustrated in FIG. 4 was output. The test chart has a repetition pattern formed of solid white and solid black on the front side of an image, and a 600-dpi, 1-dot, 1-space halftone having an area ratio of 25% on subsequent side. A density difference between the image densities of a portion corresponding to the second cycle of a photosensitive member portion on which the solid white and solid black images had been formed in the first cycle of the photosensitive member and a portion on which the halftone had been output in the second cycle was measured with a reflection densitometer (manufactured by X-Rite Inc.: 504 Spectral Densitometer).

The evaluation was performed by the following criteria concerning the density difference.

A . . . The density difference is less than 0.01.
B . . . The density difference is 0.01 or more and less than 0.02.
C . . . The density difference is 0.02 or more.

(Comprehensive Evaluation)

The lowest evaluation value out of the respective evaluation items, i.e., the sensitivity characteristic, the high-humidity deletion resistance, the image-resolving power 1, and the image memory was used in a comprehensive evaluation. It should be noted that it was judged that the effect of the present invention was obtained when the result of the comprehensive evaluation was B or more.

TABLE 3

| | Comparative | | | | | | Comparative |
|---|---|---|---|---|---|---|---|
| | Example | Example | | | | | Example |
| | 1-1 | 1-1 | 1-2 | 1-3 | 1-4 | 1-5 | 1-2 |
| Film-forming condition | 1 | 2 | 3 | 4 | 5 | 6 | 7 |
| No. | | | | | | | |
| Si atom density (×10²² atoms/cm³) | 3.60 | 3.40 | 3.15 | 2.88 | 2.70 | 2.57 | 2.22 |
| C atom density (×10²² atoms/cm³) | 2.95 | 3.40 | 3.85 | 4.32 | 4.60 | 4.78 | 5.18 |
| C/(Si + C) | 0.45 | 0.50 | 0.55 | 0.60 | 0.63 | 0.65 | 0.70 |
| Si + C atom density (×10²² atoms/cm³) | 6.55 | 6.80 | 7.00 | 7.20 | 7.30 | 7.35 | 7.40 |
| Defect density (×10¹⁹ spins/cm³) | 1.2 | 1.3 | 1.4 | 1.5 | 1.6 | 1.7 | 1.8 |
| a₂/a₁ | 0.45 | 0.45 | 0.46 | 0.46 | 0.46 | 0.47 | 0.47 |
| Sensitivity | A | A | A | A | A | B | C |
| Characteristic | | | | | | | |
| High-humidity deletion | C | B | A | A | A | A | A |
| resistance | | | | | | | |
| Image-resolving power 1 | A | A | A | A | A | A | A |
| Image memory | B | A | A | A | A | A | A |
| Comprehensive | C | B | A | A | A | B | C |
| evaluation | | | | | | | |

The results of the evaluations of the examples and the comparative examples show that the ratio (C/(Si+C)) of the a-SiC surface layer can be controlled by changing a ratio between SiH₄ and CH₄ of the raw material gases.

Setting the ratio (C/(Si+C)) to 0.50 or more improves the high-humidity deletion resistance. Meanwhile, setting the ratio (C/(Si+C)) to 0.65 or less improves the sensitivity characteristic.

When the ratio (C/(Si+C)) is set to a higher value, the Si+C atom density can be easily controlled to a higher value. This is probably because a bond distance between silicon atoms is 0.235 nm, a bond distance between a silicon atom and a carbon atom is 0.188 nm, and a bond distance between carbon atoms is 0.154 nm.

Of course, in the range of the ratio (C/(Si+C)) of more than 0.60, things are not so simple because bonding states between carbon atoms, i.e., a single bona, a double bond, and a triple bond need to be taken into consideration. However, in the range of the ratio (C/(Si+C)) of 0.60 or less, setting the ratio (C/(Si+C)) to 0.50 or more increases the Si+C atom density. In addition, the optical band gap of the SiC surface layer widens, and hence its light permeability increases and the sensitivity characteristic improves.

Meanwhile, in the range of the ratio (C/(Si+C)) of more than 0.60, the probability that carbon atoms are bonded to each other abruptly increases in association with the increase of the ratio (C/(Si+C)), and hence the number of double bonds between carbon atoms also increases. In other words, setting the ratio (C/(Si+C)) to 0.65 or less can reduce the number of the double bonds between carbon atoms, and hence the light permeability of the SiC surface layer can be increased and the sensitivity characteristic improves.

It should be noted that the quantity of light that passes through the SiC surface layer exponentially reduces relative to the thickness of the SiC surface layer. Therefore, a larger thickness of the SiC surface layer has a larger influence on the sensitivity characteristic. In actuality, the influence tends to be a problem in such a construction that the thickness of the SiC surface layer exceeds 1 μm. That is, the effect of the present invention is obtained by setting the ratio (C/(Si+C)) to 0.50 or more and 0.65 or less. Of such range, a range of 0.55 or more and 0.63 or less was more preferred.

### Example 2 and Comparative Example 2

A-Si photosensitive members for negative charging were each produced in the same manner as in Example 1 by sequentially forming a lower preventing layer, a photoconductive layer, an upper preventing layer, and a surface layer under the conditions shown in Table 1 above.

It should be noted that the flow rates of raw material gases, reaction pressure, high-frequency power, and substrate temperature at the time of the formation of the surface layer were set to conditions shown in Table 4 below. In addition, two photosensitive members were produced for each film-forming condition (layer-forming condition).

TABLE 4

| | Film-forming condition No. | | | | | | |
|---|---|---|---|---|---|---|---|
| | 8 | 9 | 10 | 4 | 11 | 12 | 13 |
| Kind and flow rate of gas | | | | | | | |
| SiH₄ [mL/min (normal)] | 22 | 21 | 20 | 19 | 18 | 17 | 16 |
| H₂ [mL/min (normal)] | 800 | 1,100 | 1,400 | 1,700 | 2,000 | 2,300 | 2,600 |
| CH₄ [mL/min (normal)] | 178 | 179 | 180 | 181 | 182 | 183 | 184 |
| Reaction pressure [Pa] | 80 | 80 | 80 | 80 | 80 | 80 | 80 |
| High-frequency power [W] | 400 | 400 | 400 | 400 | 400 | 400 | 400 |
| Substrate temperature [° C.] | 260 | 260 | 260 | 260 | 260 | 260 | 260 |

One photosensitive member for each film-forming condition produced in each of Example 2 and Comparative Example 2 was used. In addition, its Si atom density, C atom density, Si+C atom density, ratio (C/(Si+C)), defect density, and ratio a₂/a₁ of the absorbance a₂ at a wave number of 2,960 cm⁻¹ to the absorbance a₁ at a wave number of 2,890 cm⁻¹ in an infrared absorption spectrum were determined by the same methods as those of Example 1.

Meanwhile, the other photosensitive member for each film-forming condition was evaluated for its sensitivity characteristic, high-humidity deletion resistance, image-resolving power 1, and image memory by the same methods as those of Example 1 and Comparative Example 1. Further, an evaluation for an image-resolving power 2 was performed by a method to be described later. In addition, the lowest evaluation value out of the respective evaluation items, i.e., the sensitivity characteristic, the high-humidity deletion resistance, the image-resolving power 1, the image-resolving power 2, and the image memory was used in a comprehensive evaluation. It should be noted that it was judged that the effect of the present invention was obtained when the result of the comprehensive evaluation was B or more. Table 5 shows the results of the evaluations of Example 2, Comparative Example 2, and Example 1-3.

(Image-Resolving Power 2)

A reconstructed machine of a digital electrophotographic apparatus “image RUNNER ADVANCE 8105 Pro” (trade name) manufactured by Canon Inc. was used in an evaluation for the image-resolving power 2. In the reconstructed machine, the DC component of each of primary charging and a developing bias was changed to negative charging by using an external power source. In addition, a development process was changed to the reversal development process in which the exposed portion of the photosensitive member was reversed and the exposed portion of the photosensitive member was developed with toner. In the image-resolving power 2, jumping development is used as a developing apparatus for the purpose of eliminating the influence of charge injection in a developing step.

In addition, output image data was constituted so as to be capable of being directly output without through any printer driver, and an area gradation image of an area gradation dot screen (i.e., the area gradation of a dot portion to be subjected to image exposure) was output by image exposure light at a linear density of 212 lpi at 45° (212 lines per inch). Gradation data uniformly distributed among 17 levels was used for the area gradation image. At this time, a number was assigned to each gradation as follows to provide gradation levels: 17 was assigned to the densest gradation and 0 was assigned to the palest gradation.

Next, the produced photosensitive member was placed in the reconstructed electrophotographic apparatus, and an image was output on A3 paper by using the gradation data and a text mode. In order for the influence of high-humidity deletion to be eliminated, the image was output under an environment having a temperature of 22° C. and a relative humidity of 50% while the photosensitive member heater was turned on and the surface of the photosensitive member was kept at about 40° C.

The image density of the resultant image was measured with a reflection densitometer (manufactured by X-Rite Inc.: 504 Spectral Densitometer) for each gradation. It should be noted that in the reflection density measurement, 3 images were output for each gradation and the average of their densities was defined as an evaluation value.

A correlation coefficient between the evaluation value thus obtained and the gradation level was calculated, and a difference from the correlation coefficient when such gradation representation that the reflection densities at the respective gradations changed in a completely linear manner was obtained, i.e. 1.00, was determined. Then, an evaluation was performed by using, as an indicator of the image-resolving power, the ratio of a difference calculated from the correlation coefficient of the photosensitive member produced under each film-forming condition to a difference calculated from the correlation coefficient of the photosensitive member produced in Comparative Example 3-3. In the evaluation, a smaller numerical value means that the image-resolving power is more excellent.

A . . . The ratio of the difference from a correlation coefficient of 1.00 calculated from the photosensitive member produced under each film-forming condition to the difference from a correlation coefficient of 1.00 calculated from the correlation coefficient of the photosensitive member produced in Comparative Example 3-3 is 1.50 or less.

B . . . The ratio of the difference from a correlation coefficient of 1.00 calculated from the photosensitive member produced under each film-forming condition to the difference from a correlation coefficient of 1.00 calculated from the correlation coefficient of the photosensitive member produced in Comparative Example 3-3 is more than 1.50 and 2.00 or less.

C . . . The ratio of the difference from a correlation coefficient of 1.00 calculated from the photosensitive member produced under each film-forming condition to the difference from a correlation coefficient of 1.00 calculated from the correlation coefficient of the photosensitive member produced in Comparative Example 3-3 is more than 2.00.

TABLE 5

| | Comparative | | | | | | Comparative |
|---|---|---|---|---|---|---|---|
| | Example | Example | | | | | Example |
| | 2-1 | 2-1 | 2-2 | 1-3 | 2-3 | 2-4 | 2-2 |
| Film-forming | 8 | 9 | 10 | 4 | 11 | 12 | 13 |
| condition No. | | | | | | | |
| Si atom density | 2.90 | 2.82 | 2.82 | 2.88 | 2.80 | 2.86 | 2.77 |
| (×10²² atoms/cm³) | | | | | | | |
| C atom density (×10²² atoms/cm³) | 4.34 | 4.42 | 4.40 | 4.32 | 4.38 | 4.29 | 4.33 |
| C/(Si + C) | 0.60 | 0.61 | 0.61 | 0.60 | 0.61 | 0.60 | 0.61 |
| Si + C atom density | 7.24 | 7.24 | 7.22 | 7.20 | 7.18 | 7.15 | 7.10 |
| (×10²² atoms/cm³) | | | | | | | |
| Defect density (×10¹⁹ spins/cm³) | 2.5 | 2.2 | 1.8 | 1.5 | 1.1 | 0.90 | 0.75 |
| a₂/a₁ | 0.46 | 0.46 | 0.46 | 0.46 | 0.46 | 0.46 | 0.46 |
| Sensitivity | A | A | A | A | A | A | A |
| High-humidity | A | A | A | A | A | A | A |
| deletion resistance | | | | | | | |
| Image-resolving power 1 | C | B | A | A | A | A | A |
| Image-resolving power 2 | B | A | A | A | A | A | A |
| Image memory | A | A | A | A | A | B | C |
| Comprehensive | C | B | A | A | A | B | C |
| evaluation | | | | | | | |

In the a-SiC surface layer of each of the examples, the comparative examples, and Example 1-3, the mixing ratio among the raw material gases was adjusted for the hydrogen dilution amount, and hence the ratio (C/(Si+C)) of the a-SiC surface layer was able to be controlled to 0.60 or more and 0.61 or less, and a sufficient sensitivity characteristic was obtained.

In the a-SiC surface layer of each of the examples, the comparative examples, and Example 1-3, the Si+C atom density was 6.60×10²² atoms/cm³ or more and hence sufficient high-humidity deletion resistance was obtained.

It is found that in the range of the hydrogen dilution amount upon production of the a-SiC surface layer of each of the examples and the comparative examples, the defect density of the a-SiC surface layer reduces in association with the increase of the hydrogen dilution amount.

As can be seen from the results of the evaluations, an image resolution is improved by controlling the defect density of the a-SiC surface layer to 2.2×10¹⁹ spins/cm³ or less. With regard to the image resolution, the evaluation for the image-resolving power 1 shows a larger change than that of the evaluation for the image-resolving power 2, and hence the photosensitive member of the present invention is found to be also suitable in a system in which charge injection is easily performed in a developing step like two-component development. Meanwhile, a suppressing effect on the image memory is improved by controlling the defect density of the a-SiC surface layer to 9.0·10¹⁸ spins/cm³ or more.

That is, compatibility between a high image resolution and the suppression of the image memory is achieved by controlling the defect density of the a-SiC surface layer to 9.0×10¹⁸ spins/cm³ or more and 2.2×10¹⁹ spins/cm³ or less, whereby the effect of the present invention is obtained. Of such range of the defect density of the a-SiC surface layer, a range of 1.1×10¹⁹ spins/cm³ or more and 1.8×10¹⁹ spins/cm³ or less was more preferred.

### Example 3

An a-Si photosensitive member for negative charging was produced in the same manner as in Example 1 by sequentially forming a lower preventing layer, a photoconductive layer, an upper preventing layer, and a surface layer under the conditions shown in Table 1 above.

It should be noted that the flow rates of raw material gases, reaction pressure, high-frequency power, and substrate temperature at the time of the formation of the surface layer were set to conditions shown in Table 6 below. In addition, two photosensitive members were produced for each film-forming condition (layer-forming condition).

TABLE 6

Film-forming
condition No.

| | 14 | 15 |
|---|---|---|
| Kind and flow rate of gas | | |
| SiH₄ [mL/min (normal)] | 24 | 16 |
| H₂ [mL/min (normal)] | 1,400 | 1,900 |
| CH₄ [mL/min (normal)] | 176 | 184 |
| Reaction pressure [Pa] | 80 | 80 |
| High-frequency power [W] | 400 | 400 |
| Substrate temperature [° C.] | 260 | 260 |

One photosensitive member for each film-forming condition produced in Example 3 was used. In addition, its Si atom density, C atom density, Si+C atom density, ratio (C/(Si+C)), defect density, and ratio a₂/a₁ of the absorbance a₂ at a wave number of 2,960 cm⁻¹ to the absorbance a₁ at a wave number of 2,890 cm⁻¹ in an infrared absorption spectrum were determined by the same methods as those of Example 1.

Meanwhile, the other photosensitive member for each film-forming condition was evaluated for its sensitivity characteristic, high-humidity deletion resistance, image-resolving power 1, and image memory by the same methods as those of Example 1. Table 9 shows the results of the evaluations of Example 3, Example 1-3, Comparative Example 3, and Comparative Example 4.

### Comparative Example 3

An a-Si photosensitive member for negative charging was produced in the same manner as in Example 1 by sequentially forming a lower preventing layer, a photoconductive layer, an upper preventing layer, and a surface layer under the conditions shown in Table 1 above.

It should be noted that the flow rates of raw material gases, reaction pressure, high-frequency power, and substrate temperature at the time of the formation of the surface layer were set to conditions shown in Table 7 below. In addition, two photosensitive members were produced for each film-forming condition (layer-forming condition).

TABLE 7

| | Film-forming | | |
|---|---|---|---|
| | condition No. | | |
| | 16 | 17 | 18 |
| Kind and flow rate of gas | | | |
| SiH₄ [mL/min (normal)] | 53 | 44 | 39 |
| H₂ [mL/min (normal)] | 0 | 0 | 0 |
| CH₄ [mL/min (normal)] | 147 | 156 | 161 |
| Reaction pressure [Pa] | 80 | 80 | 80 |
| High-frequency power [W] | 400 | 400 | 400 |
| Substrate temperature [° C.] | 260 | 260 | 260 |

One photosensitive member for each film-forming condition produced in Comparative Example 3 was used. In addition, its Si atom density, C atom, density, Si+C atom density, ratio (C/(Si+C)), defect density, and ratio a₂/a₁ of the absorbance a₂ at a wave number of 2,960 cm⁻¹ to the absorbance a₁ at a wave number of 2,890 cm⁻¹ in an infrared absorption spectrum were determined by the same methods as those of Example 1.

Meanwhile, the other photosensitive member for each film-forming condition was evaluated for its sensitivity characteristic, high-humidity deletion resistance, image-resolving power 1, and image memory by the same methods as those of Example 1. Table 9 shows the results of the evaluations.

### Comparative Example 4

An a-Si photosensitive member for negative charging was produced in the same manner as in Example 1 by sequentially forming a lower preventing layer, a photoconductive layer, an upper preventing layer, and a surface layer under the conditions shown in Table 1 above.

It should be noted that the flow rates of raw material gases, reaction pressure, high-frequency power, and substrate temperature at the time of the formation of the surface layer were set to conditions shown in Table 8 below. In addition, two photosensitive members were produced for each film-forming condition (layer-forming condition).

TABLE 8

| | Film-forming | | |
|---|---|---|---|
| | condition No. | | |
| | 19 | 20 | 21 |
| Kind and flow rate of gas | | | |
| SiH₄ [mL/min (normal)] | 35 | 35 | 26 |
| H₂ [mL/min (normal)] | 0 | 0 | 0 |
| CH₄ [mL/min (normal)] | 190 | 190 | 150 |
| Reaction pressure [Pa] | 70 | 70 | 70 |
| High-frequency power [W] | 550 | 750 | 800 |
| Substrate temperature [° C.] | 290 | 290 | 290 |

One photosensitive member for each film-forming condition produced in Comparative Example 4 was used. In addition, its Si atom density, C atom density, Si+C atom density, ratio (C/(Si+C)), detect density, and ratio a₂/a₁ of the absorbance a₂ at a wave number of 2,960 cm⁻¹ to the absorbance a₁ at a wave number of 2,890 cm⁻¹ in an infrared absorption spectrum were determined by the same methods as those of Example 1.

Meanwhile, the other photosensitive member for each film-forming condition was evaluated for its sensitivity characteristic, high-humidity deletion resistance, image-resolving power 1, and image memory by the same methods as those of Example 1. Table 9 shows the results of the evaluations.

TABLE 9

| | Example | | | Comparative Example | | | | | |
|---|---|---|---|---|---|---|---|---|---|
| | 3-1 | 1-3 | 3-2 | 3-1 | 3-2 | 3-3 | 4-1 | 4-2 | 4-3 |
| Film-forming condition No. | 14 | 4 | 15 | 16 | 17 | 18 | 19 | 20 | 21 |
| Si atom density (×10 [symbol] atoms/cm³) | 3.22 | 2.88 | 2.72 | 2.75 | 2.48 | 2.41 | 3.21 | 2.89 | 2.89 |
| C atom density | 3.93 | 4.32 | 4.63 | 3.36 | 3.72 | 4.10 | 4.09 | 4.51 | 4.92 |
| (×10²² atoms/cm³) | | | | | | | | | |
| C/(Si + C) | 0.55 | 0.60 | 0.63 | 0.55 | 0.60 | 0.63 | 0.56 | 0.61 | 0.63 |
| Si + C atom density | 7.15 | 7.20 | 7.35 | 6.10 | 6.20 | 6.50 | 7.30 | 7.40 | 7.81 |
| (×10²² atoms/cm²) | | | | | | | | | |
| Defect density (×10¹⁹ spins/cm³) | 1.3 | 1.3 | 1.3 | 1.5 | 1.8 | 2.0 | 2.5 | 3.1 | 3.3 |
| a₂/a₁ | 0.45 | 0.46 | 0.46 | 0.55 | 0.57 | 0.58 | 0.40 | 0.42 | 0.43 |
| Sensitivity characteristic | A | A | A | A | A | A | A | A | — |
| High-humidity deletion | A | A | A | C | C | C | A | A | A |
| resistance | | | | | | | | | |
| Image-resolving power 1 | A | A | A | A | A | — | C | C | C |
| Image memory | A | A | A | A | A | A | A | A | A |
| Comprehensive evaluation | A | A | A | C | C | C | C | C | C |

[symbol]

indicates data missing or illegible when filed

The ratio (C/(Si+C)), Si+C atom density, and defect density of the a-SiC surface layer produced in Example 3 are optimized, and hence good results are obtained in all of the items, i.e., the sensitivity characteristic, the high-humidity deletion resistance, the image-resolving power 1, and the image memory, and the effect of the present invention is obtained.

The photosensitive member of Comparative Example 3 produced without performing hydrogen dilution upon formation of the a-SiC surface layer was inferior in the high-humidity deletion resistance to Example 3 because the Si+C atom density of Comparative Example 3 was lower than a proper range, though the ratio (C/(Si+C)) and defect density of Comparative Example 3 fell within proper ranges.

The photosensitive member of Comparative Example 4 produced without performing hydrogen dilution upon formation of the a-SiC surface layer, and by setting the high-frequency power and the substrate temperature to high values had a defect density higher than a proper range, though the ratio (C/(Si+C)) and Si+C atom density of Comparative Example 4 fell within proper ranges. Accordingly, the photosensitive member of Comparative Example 4 was inferior in the image-resolving power 1 to Example 3.

### Example 4 and Comparative Example 5

A-Si photosensitive members for negative charging were each produced in the same manner as in Example 1 by sequentially forming a lower preventing layer, a photoconductive layer, an upper preventing layer, and a surface layer under the conditions shown in Table 1 above.

It should be noted that the flow rates of raw material gases, reaction pressure, high-frequency power, and substrate temperature at the time of the formation of the surface layer were set to conditions shown in Table 10 below. In addition, two photosensitive members were produced for each film-forming condition (layer-forming condition).

TABLE 10

Film-forming condition No.

| | 22 | 23 | 24 | 25 |
|---|---|---|---|---|
| Kind and flow rate of gas | | | | |
| SiH₄ [mL/min (normal)] | 22 | 22 | 22 | 22 |
| H₂ [mL/min (normal)] | 800 | 800 | 800 | 800 |
| CH₄ [mL/min (normal)] | 178 | 178 | 178 | 178 |
| Reaction pressure [Pa] | 106 | 133 | 155 | 180 |
| High-frequency power [W] | 400 | 400 | 400 | 400 |
| Substrate temperature [° C.] | 260 | 260 | 260 | 260 |

One photosensitive member for each film-forming condition produced in each of Example 4 and Comparative Example 4 was used. In addition, its Si atom density, C atom density, Si+C atom density, ratio (C/(Si+C)), defect density, and ratio a₂/a₁ of the absorbance a₂ at a wave number of 2,960 cm⁻¹ to the absorbance a₁ at a wave number of 2,890 cm⁻¹ in an infrared absorption spectrum were determined by the same methods as those of Example 1.

Meanwhile, the other photosensitive member for each film-forming condition was evaluated for its sensitivity characteristic, high-humidity deletion resistance, image-resolving power 1, and image memory by the same methods as those of Example 1. Table 11 shows the results of the evaluations of Example 4, Comparative Example 5, and Comparative Example 2-1.

TABLE 11

| | Compar- | | | | Compar- |
|---|---|---|---|---|---|
| | ative | | | | ative |
| | Example | Example | | | Example |
| | 2-1 | 4-1 | 4-2 | 4-3 | 5 |
| Film-forming condition No. | 8 | 22 | 23 | 24 | 25 |
| Si atom density | 2.90 | 2.84 | 2.76 | 2.68 | 2.60 |
| (×10²² atoms/cm³) | | | | | |
| C atom density | 4.34 | 4.26 | 4.14 | 4.02 | 3.90 |
| (×10²² atoms/cm³) | | | | | |
| C/(Si + C) | 0.60 | 0.60 | 0.60 | 0.60 | 0.60 |
| Si + C atom density | 7.24 | 7.10 | 6.90 | 6.70 | 6.50 |
| (×10²² atoms/cm³) | | | | | |
| Defect density | 2.50 | 2.00 | 1.30 | 0.90 | 0.70 |
| (×10¹⁹ spins/cm³) | | | | | |
| a₂/a₁ | 0.46 | 0.49 | 0.52 | 0.54 | 0.57 |
| Sensitivity characteristic | A | A | A | A | A |
| High-humidity deletion | A | A | A | B | C |
| resistance | | | | | |
| Image-resolving power 1 | C | B | A | A | A |
| Image memory | A | A | A | A | B |
| Comprehensive evaluation | C | B | A | B | C |

As can be seen from the results of the evaluations, setting the reaction pressure to a low value at the time of the formation of the a-SiC surface layer tends to increase the Si-s-C atom density, and hence the high-humidity deletion resistance improves. Even in a region where the Si+C atom density is sufficient, the high-humidity deletion resistance reduces when the ratio a₂/a₁ becomes excessively high. Accordingly, it can be said that the ratio a₂/a₁ is more preferably controlled to 0.52 or less from the viewpoint of the high-humidity deletion resistance.

### Example 5

An a-Si photosensitive member for positive charging was produced in the same manner as in Example 1 by sequentially forming a lower preventing layer, a photoconductive layer, and a surface layer under the conditions shown in Table 12 below.

TABLE 12

| | Lower | | |
|---|---|---|---|
| | preventing | Photoconductive | Surface |
| | layer | layer | layer |
| Kind and flow rate of gas | | | |
| SiH₄ [mL/min (normal)] | 350 | 450 | 19 |
| H₂ [mL/min (normal)] | 750 | 2,200 | 1,700 |
| B₂H₆ [ppm] (with respect | 1,500 | 1 | |
| to SiH₄) | | | |
| NO [mL/min (normal)] | 10 | | |
| CH₄ [mL/min (normal)] | | | 181 |
| Reaction pressure [Pa] | 40 | 80 | 80 |
| High-frequency power [W] | 400 | 800 | 400 |
| Substrate temperature | 260 | 260 | 260 |
| [° C.] | | | |
| Thickness [μm] | 3 | 25 | 1 |

The photosensitive member produced in Example 5 was used. Then, the photosensitive member was evaluated for its image-resolving power 1 and image memory by the same methods as those of Example 1; provided that the evaluation machine was changed to a process for positive charging because the a-Si photosensitive member for positive charging was produced in Example 5. The process for positive charging is a positive development process in which the DC component of each of primary charging and a developing bias is changed to positive charging and the charged portion of the photosensitive member is developed with toner.

In addition, a sample obtained by laminating only the lower preventing layer and the photoconductive layer was used as a reference sample to be used in the measurement of the thickness of the surface layer. Table 17 shows the results of the evaluations of Example 5.

### Example 6

An a-Si photosensitive member for positive charging was produced in the same manner as in Example 1 by sequentially forming a lower preventing layer, a photoconductive layer, an intermediate layer, and a surface layer under the conditions shown in Table 13 below.

TABLE 13

| | Lower | Photo- | | |
|---|---|---|---|---|
| | preventing | conductive | Intermediate | Surface |
| | layer | layer | layer | layer |
| Kind and flow rate | | | | |
| of gas | | | | |
| SiH₄ [mL/min | 350 | 450 | 250 | 19 |
| (normal)] | | | | |
| H₂ [mL/min (normal)] | 750 | 2,200 | | 1,700 |
| B₂H₆ [ppm] (with | 1,500 | 1 | | |
| respect to SiH₄) | | | | |
| NO [mL/min (normal)] | 10 | | | |
| CH₄ [mL/min (normal)] | | | 250 | 181 |
| Reaction pressure | 40 | 80 | 40 | 80 |
| [Pa] | | | | |
| High-frequency power | 400 | 800 | 400 | 400 |
| [W] | | | | |
| Substrate | 260 | 260 | 260 | 260 |
| temperature [° C.] | | | | |
| Thickness [μm] | 3 | 25 | 0.2 | 1 |

The photosensitive member produced in Example 6 was used. Then, the photosensitive member was evaluated for its sensitivity characteristic, high-humidity deletion resistance, image-resolving power 1, and image memory by the same methods as those of Example 5. Table 17 shows the results of the evaluations of Example 6.

### Example 7

An a-Si photosensitive member for positive charging was produced in the same manner as in Example 1 by sequentially forming a lower preventing layer, a photoconductive layer, an intermediate layer 1, an intermediate layer 2, an intermediate layer 3, and a surface layer under the conditions shown in Table 14 below.

TABLE 14

| | Lower | | | | | |
|---|---|---|---|---|---|---|
| | preventing | Photoconductive | Intermediate | Intermediate | Intermediate | Surface |
| | layer | layer | layer 1 | layer 2 | layer 3 | layer |
| Kind and flow rate | | | | | | |
| of gas | | | | | | |
| SiH₄ [mL/min | 350 | 450 | 310 | 250 | 70 | 19 |
| (normal)] | | | | | | |
| H₂ [mL/min | 750 | 2,200 | | | | 1,700 |
| (normal)] | | | | | | |
| B₂H₆ [ppm] (with | 1,500 | 1 | | | | |
| respect to SiH₄) | | | | | | |
| No [mL/min | 10 | | | | | |
| (normal)] | | | | | | |
| CH₄ [mL/min | | | 130 | 250 | 580 | 181 |
| (normal)] | | | | | | |
| Reaction pressure | 40 | 80 | 40 | 40 | 40 | 80 |
| [Pa] | | | | | | |
| High-frequency | 400 | 800 | 400 | 400 | 400 | 400 |
| power [W] | | | | | | |
| Substrate | 260 | 260 | 260 | 260 | 260 | 260 |
| temperature [° C.] | | | | | | |
| Thickness [μm] | 3 | 25 | 0.05 | 0.12 | 0.07 | 1 |

The photosensitive member produced in Example 7 was used. Then, the photosensitive member was evaluated for its sensitivity characteristic, high-humidity deletion resistance, image-resolving power 1, and image memory by the same methods as those of Example 5. Table 17 shows the results of the evaluations of Example 7.

### Example 8

An a-Si photosensitive member for positive charging was produced in the same manner as in Example 1 by sequentially forming a lower preventing layer, a photoconductive layer, an intermediate layer (change layer), and a surface layer under the conditions shown in Table 15 below.

TABLE 15

| | Lower | | Intermediate | |
|---|---|---|---|---|
| | preventing | Photoconductive | layer (change | Surface |
| | layer | layer | layer) | layer |
| Kind and flow | | | | |
| rate of gas | | | | |
| SiH₄ [mL/min | 350 | 450 | 200 → 44 | 19 |
| (normal)] | | | | |
| H₂ [mL/min | 750 | 2,200 | | 1,700 |
| (normal)] | | | | |
| B₂H₆ [ppm] | 1,500 | 1 | | |
| (with respect | | | | |
| to SiH₄) | | | | |
| NO [mL/min | 10 | | | |
| (normal)] | | | | |
| CH₄ [mL/min | | | 0 → 156 | 181 |
| (normal)] | | | | |
| Reaction | 40 | 80 | 80 | 80 |
| pressure [Pa] | | | | |
| High-frequency | 400 | 800 | 400 | 400 |
| power [W] | | | | |
| Substrate | 260 | 260 | 260 | 260 |
| temperature | | | | |
| [° C.] | | | | |
| Thickness [μm] | 3 | 25 | 0.5 | 1 |

The photosensitive member produced in Example 8 was used. Then, the photosensitive member was evaluated for its sensitivity characteristic, high-humidity deletion resistance, image-resolving power 1, and image memory by the same methods as those of Example 5. Table 17 shows the results of the evaluations of Example 8.

### Comparative Example 6

An a-Si photosensitive member for positive charging was produced in the same manner as in Example 1 by sequentially forming a lower preventing layer, a photoconductive layer, and a surface layer under the conditions shown in Table 16 below.

TABLE 16

| | Lower | | |
|---|---|---|---|
| | preventing | Photoconductive | Surface |
| | layer | layer | layer |
| Kind and flow rate of gas | | | |
| SiH₄ [mL/min (normal)] | 350 | 450 | 35 |
| H₂ [mL/min (normal)] | 750 | 2,200 | |
| B₂H₆ [ppm] (with respect to | 1,500 | 1 | |
| SiH₄) | | | |
| NO [mL/min (normal)] | 10 | | |
| CH₄ [mL/min (normal)] | | | 190 |
| Reaction pressure [Pa] | 40 | 80 | 70 |
| High-frequency power [W] | 400 | 800 | 750 |
| Substrate temperature [° C.] | 260 | 260 | 290 |
| Thickness [μm] | 3 | 25 | 1 |

The photosensitive member produced in Comparative Example 6 was used. Then, the photosensitive member was evaluated for its sensitivity characteristic, high-humidity deletion resistance, image-resolving power 1, and image memory by the same methods as those of Example 5. Table 17 shows the results of the evaluations of Comparative Example 6.

TABLE 17

| | | | | | Comparative |
|---|---|---|---|---|---|
| | Example | | | | Example |
| | 5 | 6 | 7 | 8 | 6 |
| Sensitivity | A | A | A | A | A |
| characteristic | | | | | |
| High-humidity deletion | A | A | A | A | A |
| resistance | | | | | |
| Image-resolving power 1 | B | A | A | A | C |
| Image memory | B | B | A | A | A |
| Comprehensive evaluation | B | B | A | A | C |

Comparison between the results of the evaluations of Example 5 and Comparative Example 6 showed that the use of the a-SiC surface layer of the present invention improved the image-resolving power in the photosensitive member for positive charging the same as in the photosensitive member for negative charging, and the effect of the present invention was obtained.

Next, it is assumed from comparison between Examples 5 and 6 that the formation of the intermediate layer between the photoconductive layer and the surface layer enabled a photocarrier produced in the photoconductive layer by exposure to transfer smoothly from the photoconductive layer to the surface layer, and hence the image-resolving power improved.

Further, it is assumed from comparison among Examples 6 to 8 that when the intermediate layer between the photoconductive layer and the surface layer was formed of multiple layers or was formed as a change layer, the photocarrier produced in the photoconductive layer by exposure was able to transfer from the photoconductive layer to the surface layer in an additionally smooth manner. Probably as a result of the foregoing, a suppressing effect on the image memory improved.

In other words, a construction in which the intermediate layer is formed between the photoconductive layer and the surface layer is a more preferred construction of the present invention, and a construction in which the intermediate layer is formed of multiple layers or is formed as a change layer is a still more preferred construction.

### Example 9

An a-Si photosensitive member for negative charging was produced in the same manner as in Example 1 by sequentially forming a lower preventing layer, a photoconductive layer, an intermediate layer 1, an intermediate layer 2, an intermediate layer 3, and a surface layer under the conditions shown in Table 18 below.

TABLE 18

| | Lower | | | | | |
|---|---|---|---|---|---|---|
| | preventing | Photoconductive | Intermediate | Intermediate | Intermediate | Surface |
| | layer | layer | layer 1 | layer 2 | layer 3 | layer |
| Kind and flow rate of | | | | | | |
| gas | | | | | | |
| SiH₄ [mL/min (normal)] | 350 | 450 | 310 | 250 | 70 | 19 |
| H₂ [mL/min (normal)] | 750 | 2,200 | | | | 1,700 |
| B₂H₆ [ppm] (with | | | | 150 | | |
| respect to SiH₄) | | | | | | |
| No [mL/min (normal)] | 10 | | | | | |
| CH₄ [mL/min (normal)] | 700 | | 130 | 250 | 580 | 181 |
| Reaction pressure [Pa] | 40 | 80 | 40 | 40 | 40 | 80 |
| High-frequency power | 400 | 800 | 400 | 400 | 400 | 400 |
| [W] | | | | | | |
| Substrate temperature | 260 | 220 | 260 | 260 | 260 | 260 |
| [° C.] | | | | | | |
| Thickness [μm] | 3 | 25 | 0.05 | 0.12 | 0.07 | 1 |

The photosensitive member produced in Example 9 was used. Then, the photosensitive member was evaluated for its sensitivity characteristic, high-humidity deletion resistance, image-resolving power 1, and image memory by the same methods as those of Example 1. Table 19 shows the results of the evaluations of Example 9 and Example 1-3.

TABLE 19

Example

| | 1-3 | 9 |
|---|---|---|
| Sensitivity characteristic | A | A |
| High-humidity deletion resistance | A | A |
| Image-resolving power 1 | A | A |
| Image memory | A | A |
| Comprehensive evaluation | A | A |

As can be seen from the results of the evaluations, the photosensitive member of Example 9 obtained characteristics comparable to or better than those of the photosensitive member of Example 1-3. In the photosensitive member of Example 9, slightly better results were obtained in the image-resolving power 1 and the image memory, though no difference was observed in terms of the evaluation criterions.

### Example 10

An a-Si photosensitive member for negative charging was produced in the same manner as in Example 1 by sequentially forming a lower preventing layer, a photoconductive layer, an upper preventing layer, and a surface layer under conditions shown in Table 20 below. It should be noted that the thickness of the surface layer was set to any one of the three levels, i.e., 1.5 μm, 2.0 μm, and 2.5 μm.

TABLE 20

| | | | Intermediate | |
|---|---|---|---|---|
| | Lower | Photo- | layer (upper | |
| | preventing | conductive | preventing | Surface |
| | layer | layer | layer) | layer |
| Kind and flow rate of gas | | | | |
| SiH₄ (mL/min (normal)] | 350 | 450 | 250 | 19 |
| H₂ [mL/min (normal)] | 750 | 2,200 | | 181 |
| B₂H₆ [ppm] (with respect | | | 150 | |
| to SiH₄) | | | | |
| NO [mL/min (normal)] | 10 | | | |
| CH₄ [mL/min (normal)] | 700 | | 250 | 1,700 |
| Reaction pressure [Pa] | 40 | 80 | 40 | 80 |
| High-frequency power | 400 | 800 | 400 | 400 |
| [W] | | | | |
| Substrate temperature | 260 | 220 | 260 | 260 |
| [° C.] | | | | |
| Thickness [μm] | 3 | 25 | 0.2 | * |

The photosensitive member produced in each of Example 10 and Example 1-3 was evaluated for its sensitivity characteristic, high-humidity deletion resistance, image-resolving power 1, and image memory by the same methods as those of Example 1. Further, the photosensitive member produced in each of Example 10 and Example 1-3 was evaluated for its film adhesiveness by the following criteria. Table 22 shows the results of the evaluations of Example 10, Example 1-3, Comparative Example 7, and Comparative Example 4-2.

A . . . No film peeling occurred.
B . . . Film peeling occurred in less than 10% of the surface area of the photosensitive member.
C . . . Film peeling occurred in 10% or more of the surface area of the photosensitive member.

### Comparative Example 7

An a-Si photosensitive member for negative charging was produced in the same manner as in Example 1 by sequentially forming a lower preventing layer, a photoconductive layer, an upper preventing layer, and a surface layer under conditions shown in Table 21 below. It should be noted that the thickness of the surface layer was set to any one of the three levels, i.e., 1.5 μm, 2.0 μm, and 2.5 μm.

TABLE 21

| | | | Intermediate | |
|---|---|---|---|---|
| | Lower | Photo- | layer (upper | |
| | preventing | conductive | preventing | Surface |
| | layer | layer | layer) | layer |
| Kind and flow rate of gas | | | | |
| SiH₄ [mL/min (normal)] | 350 | 450 | 250 | 35 |
| H₂ [mL/min (normal)] | 750 | 2,200 | | 190 |
| B₂H₆ [ppm] (with respect | | | 150 | |
| to SiH₄) | | | | |
| NO [mL/min (normal)] | 10 | | | |
| CH₄ [mL/min (normal)] | 700 | | 250 | |
| Reaction pressure [Pa] | 40 | 80 | 40 | 70 |
| High-frequency power | 400 | 800 | 400 | 750 |
| [W] | | | | |
| Substrate temperature | 260 | 220 | 260 | 290 |
| [° C.] | | | | |
| Thickness [μm] | 3 | 25 | 0.2 | * |

The photosensitive member produced in each of Comparative Example 7 and Comparative Example 4-2 was evaluated for its sensitivity characteristic, high-humidity deletion resistance, image-resolving power 1, and image memory by the same methods as those of Example 1, and was evaluated for its film adhesiveness. Table 22 shows the results of the evaluations of Example 10, Example 1-3, Comparative Example 7, and Comparative Example 4-2.

TABLE 22

| | | | | | Comparative | | | |
|---|---|---|---|---|---|---|---|---|
| | Example | | | | Example | | | |
| | 1-3 | 10-1 | 10-2 | 10-3 | 4-2 | 7-1 | 7-2 | 7-3 |
| Thickness of surface | 1.0 | 1.5 | 2.0 | 2.5 | 1.0 | 1.5 | 2.0 | 2.5 |
| layer (μm) | | | | | | | | |
| Sensitivity | A | A | A | A | A | — | — | — |
| characteristic | | | | | | | | |
| High-humidity deletion | A | A | A | A | A | — | — | — |
| resistance | | | | | | | | |
| Image-resolving power 1 | A | A | A | A | C | — | — | — |
| Image memory | A | A | A | B | A | — | — | — |
| Film adhesiveness | A | A | A | A | A | C | C | C |
| Comprehensive | A | A | A | B | C | C | C | C |
| evaluation | | | | | | | | |

As can be seen from the results of the evaluations, no film peeling occurred in the photosensitive member produced in Example 10 and hence its adhesiveness was excellent. On the other hand, in the photosensitive member produced in Comparative Example 7, film peeling occurred when the thickness of the surface layer was 1.5 μm or more. It has been found from the results of the evaluations of Comparative Example 4-2 shown in Table 9 that the photosensitive member of the comparative example has a high defect density. A high defect density may mean that in a process for the deposition of a film, the film is deposited while a residual stress is not sufficiently alleviated. Accordingly, it is assumed that in association with the thickness, the residual stress to be applied to the photosensitive member increased to cause the film peeling.

Accordingly, it is assumed that according to the present invention in which the defect density was set to fall within a proper range, no film peeling occurred even when the a-SiC surface layer was laminated in a thick manner.

It should be noted that the photosensitive member of Comparative Example 7 in which film peeling had occurred was not evaluated for its sensitivity characteristic, high-humidity deletion resistance, image-resolving power 1, and image memory.

In addition, it is found from the results of the evaluations of the photosensitive member produced in Example 10 that the suppressing effect on the image memory improves as the thickness of the SiC surface layer reduces. This probably results from the fact that a resistance of the SiC surface layer in the thickness direction increases as the thickness increases.

It is assumed from the foregoing that the thickness of the surface layer is preferably set to 2.0 μm or less from the viewpoint of the image memory, though the surface layer is preferably laminated in a thick manner from the viewpoint of the wear resistance of the photosensitive member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2013-111363, filed May 27, 2013, and No. 2014-021787, filed Feb. 6, 2014, which are hereby incorporated by reference herein in their entirety.

What is claimed is:

1. An electrophotographic photosensitive member, comprising:
a photoconductive layer; and
a surface layer comprising hydrogenated amorphous silicon carbide on the photoconductive layer, wherein:
a ratio (C/(Si+C)) of a number of carbon atoms (C) to a sum of a number of silicon atoms (Si) and the number of the carbon atoms (C) in the surface layer is 0.50 or more and 0.65 or less;
a sum of an atom density of the silicon atoms and an atom density of the carbon atoms in the surface layer is 6.60×10²² atoms/cm³ or more; and
a defect density of the surface layer determined by electron spin resonance measurement is 9.0×10¹⁸ spins/cm³ or more and 2.2×10¹⁹ spins/cm³ or less.

2. The electrophotographic photosensitive member according to claim 1, wherein the ratio (C/(Si+C)) of the number of the carbon atoms (C) to the sum of the number of the silicon atoms (Si) and the number of the carbon atoms (C) in the surface layer is 0.55 or more and 0.63 or less.

3. The electrophotographic photosensitive member according to claim 1, wherein the defect density of the surface layer determined by the electron spin resonance measurement is 1.1×10¹⁹ spins/cm³ or more and 1.8×10¹⁹ spins/cm³ or less.

4. The electrophotographic photosensitive member according to claim 1, wherein a ratio a₂/a₁ of an absorbance a₂ at a wave number of 2,960 cm⁻¹ to an absorbance a₁ at a wave number of 2,890 cm⁻¹ in an infrared absorption spectrum of the surface layer is 0.52 or less.

5. The electrophotographic photosensitive member according to claim 1, further comprising
an intermediate layer between the photoconductive layer and the surface layer; wherein:
the intermediate layer comprises a layer comprising hydrogenated amorphous silicon carbide; and
a ratio (C/(Si+C)) of a number of carbon atoms (C) to a sum of a number of silicon atoms (Si) and the number of the carbon atoms (C) in the intermediate layer is smaller than the ratio (C/(Si+C)) of the number of the carbon atoms (C) to the sum of the number of the silicon atoms (Si) and the number of the carbon atoms (C) in the surface layer.

6. The electrophotographic photosensitive member according to claim 5, wherein:
the intermediate layer comprises multiple layers comprising hydrogenated amorphous silicon carbide in which the ratio (C/(Si+C)) changes in a stepwise manner; and
the ratio (C/(Si+C)) in the intermediate layer monotonically increases from the photoconductive layer toward the surface layer.

7. The electrophotographic photosensitive member according to claim 5, wherein:
the intermediate layer comprises a layer comprising hydrogenated amorphous silicon carbide in which the ratio (C/(Si+C)) changes continuously; and
the ratio (C/(Si+C)) in the intermediate layer monotonically increases from the photoconductive layer toward the surface layer.

8. The electrophotographic photosensitive member according to claim 1, wherein the surface layer has a thickness of 1.5 μm or more.

9. An electrophotographic apparatus, comprising:
the electrophotographic photosensitive member according to claim 1;
a charging device;
an exposing device;
a developing device;
a transferring device; and
a cleaning device.

10. The electrophotographic apparatus according to claim 9, wherein the developing device comprises a developing device employing a two-component development system.
